(19) United States
(12) Patent Application Publication
(10) Pub. No.: US 2017/0185715 A9
(43) Pub. Date: Jun. 29, 2017

(54) Federated Collaborative Medical Records System Utilizing Cloud Computing Network and Methods

(71) Applicant: Douglas K. Smith, San Antonio, TX (US)

(72) Inventor: Douglas K. Smith, San Antonio, TX (US)

(21) Appl. No.: 14/205,370

(22) Filed: Mar. 12, 2014

Related U.S. Application Data
(60) Provisional application No. 61/802,093, filed on Mar. 15, 2013.

(51) Int. Cl. G06F 19/00; G06F 21/62

(52) U.S. Cl. CPC G06F 19/322; G06F 21/6263

(57) ABSTRACT

A cloud-based, federated collaborative medical records system and methods, in the preferred embodiments, features a variety of mechanisms to enable end users to store, access, edit, and share health information, on demand. A key aspect of said embodiments involves the circumvention of barriers preventing the transfer of health information placed upon other electronic medical records systems and related systems preventing users who are not part of a specific business entity from accessing the records. The preferred embodiments of the present invention delegate control over medical information to those individuals who need access to such medical information at the appropriate time.

### CROSS-REFERENCE TO RELATED APPLICATION

This application claims the benefit of U.S. Provisional Application No. 61/802,093, filed Mar. 15, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD

The present disclosure relates generally to communication systems and in particular electronic health information systems and health information exchanges, where a network of users and health information are maintained in compliance with government regulations regarding electronic protected health information for patients (such regulations as, among others, the Health Information Technology for Economic and Clinical Health Act (HITECH Act) of the American Recovery and Reinvestment Act of 2009 (ARRA), Public L. 111-5, enacted Feb. 17, 2009, and the Security Standards for the Protection of Electronic Protected Health Information (the ePHI Security Rule) published Feb. 20, 2003 (45 C.F.R. Part 160 and Part 164, Subparts A and C; the Health Insurance Portability and Accountability Act (hereinafter “HIPAA”); (Health Insurance Portability and Accountability Act of 1998 (HIPAA); Public L. 104-191, 101 Stat. 1936, enacted Aug. 21, 1996.)).

### BACKGROUND

The Health Information Technology for Economic and Clinical Health Act (HITECH Act) as part of the American Recovery and Reinvestment Act of 2009 (ARRA). The ARRA creates a financial incentive program for physicians and healthcare providers to adopt “meaningful use” of electronic medical records (EMR) but added increased standards for electronic transmission of medical records to qualify for financial incentives that include a requirement for patient portals to access and interact with their medical records. (See Phase 2 of the Meaningful Use (Proposed Final Ruling released March 2012, The Health Information Technology for Economic and Clinical Health Act (HITECH Act) §13410(d) (see eg. Meaningful Use (of Health Information Technology) Proposed Final Rule March 2012 (addressing the privacy and security concerns of ePHI)))). Today, although federal regulatory mandates for network infrastructure interoperability between disparate medical entities remains very problematic, many medical entities are currently focusing on creating internal protocols in compliance with HIPAA and HITECH regulations among others. Health privacy and security experts remain quite reluctant to allow unrestricted access or data sharing with other medical entities and third parties due to security concerns and proprietary intranet work investment interests. Moreover, under the present HITECH Act, a breach where electronic protected health information is compromised or a security vulnerability in the network architecture by one medical entity could affect all of that entity's partners and unfairly expose a medial entity to unintended liability, penalties, damages, fines, and other costs. Inasmuch, there exists is an urgent need for a third party intermediary to broker access to electronic protected health information stored in disparate medical entity proprietary intra networks while dynamically refreshing such access in accordance with user changes, changes from algorithms executed by an medical entity's network architecture, and changes in the existing governmental laws and regulations for health information including, among others security and privacy regulations, such regulations as, among others, the Security Standards for the Protection of Electronic Protected Health Information (the Security Rule) published Feb. 20, 2003 (45 C.F.R. Part 160 and Part 164, Subparts A and C) and established standards for protecting Health Information (ePHI) conveyed by electronic means (hence “ePHI”) (hereinafter referred to as “the ePHI security rule”); the Health Insurance Portability and Accountability Act (hereafter “HIPAA”) (Health Insurance Portability and Accountability Act of 1996 (HIPAA)); Public L. 104-191, 101 Stat. 1936, enacted Aug. 21, 1996), (see also the HIPAA Privacy Rule (See 45 C.F.R. §164.530(c) (technical safeguards for ePHI)) and the HIPAA Security Rule (See 45 C.F.R §§164.308, 164.310, and 164.312 (technical safeguards for ePHI)) (HIPAA Privacy and Security Rules refer to regulations for protecting the privacy and security of health information as developed by the Secretary of the U.S. Department of Health and Human Services (HHS).)); and the Health Information Technology for Economic and Clinical Health Act (HITECH Act) §13410(d) (see eg. Meaningful Use (of Health Information Technology) Proposed Final Rule March/2012 (addressing the privacy and security concerns of ePHI)); HITECH Act as part of the American Recovery and Reinvestment Act of 2009 (ARRA), Public L. 111-5, enacted Feb. 17, 2009 (hereinafter, collectively, referred to as “The HITECH Act”).

The Meaningful Use provisions under the newly implemented HITECH Act now creates a financial incentive program for physicians and healthcare providers to adopt “meaningful use” of electronic medical records (EMR) as opposed to paper files. In effect, the “Meaningful Use” provisions have added increased standards for electronic transmission of medical records to qualify for financial incentives that are currently technically difficult and potentially quite costly to implement as many physician and healthcare provider system information technology network architectures are proprietary and incompatible with others.

To the tedious discomfort of every sick patient, this process of each healthcare system initially requiring the patient to fill out a HIPAA authorization form for accessing the patient's medical files is routinely repeated today, such as while the patient moves between healthcare systems including doctors' offices or if the patient's existing healthcare system lost the authorization form. This time-consuming, expensive, and highly bureaucratic protocol is often encouraged in that internal practices of healthcare administration from each healthcare system are different from that of most other healthcare systems. Illustratively, from a business perspective, each healthcare administration is not readily willing to share patient information while in the context of revealing sensitive aspects of that providing healthcare system's internal filing systems, procedures, and other proprietary investments to another healthcare system that create detrimental competitive and legal risks.

In this present paper-centric system, there exists no single or direct way to update access to an individual patients medical records. As patients frequently change providers or health professionals migrate between healthcare systems, the most current revisions to the paper authorization HIPAA forms for accessing a patient's medical files are always needed but rarely ever provided. Moreover, present day healthcare systems do not typically permit access to patient medical information over the internet although implementation of a patient portal is mandated for stage 2 and 3 compliance of the ARRA's “meaningful use” provisions.

Health care professionals are currently beginning to use computer based devices and software to encourage individual patients to access patient ePHI from multiple, often incompatible, medical entities via patient portals. Mobile device access to ePHI through most patient portals is achieved typically with software downloads that regrettably remain on that mobile device even after completion of a login session. Unfortunately, known patient login sessions are prohibitively cumbersome for the frail, invalid, and those individuals that have difficulty interfacing with computer based devices as well as generally adjusting to the rapidly changing technological environment.

There is a critical need for a single user login to a patient portal provided by a independent, cloud-based login service. There exists a further need to participating medical entities a system for accounting patient activity with the patient portal in compliance with government requirements such as the meaningful use requirement. There exists a need for providing patient incentives for individual patient compliance while using patient portals with respect to government regulations such as meaningful use. There exists a further need for a cloud-based patient ePHI management service including permitting patients to set privacy settings regarding their ePHI for specific participating medical entities.

### SUMMARY OF THE INVENTION

At the heart of the present invention is the discovery that a cloud-based, federated medical records system and associated methods will provide the greatest number of stakeholders access to medical information when it is needed. The federated cloud based medical records system and associated methods disclosed herein automatically track the activity of medical providers and patients when accessing health information, thus enabling compliance with federal regulations. The system also enables both patient users and medical professional users to set privacy settings to distribute control over health informations to those who most appropriately should have such control.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required

FIG. 1, is a schematic diagram of the Federated Collaborative Medical Record (FCMR) System.

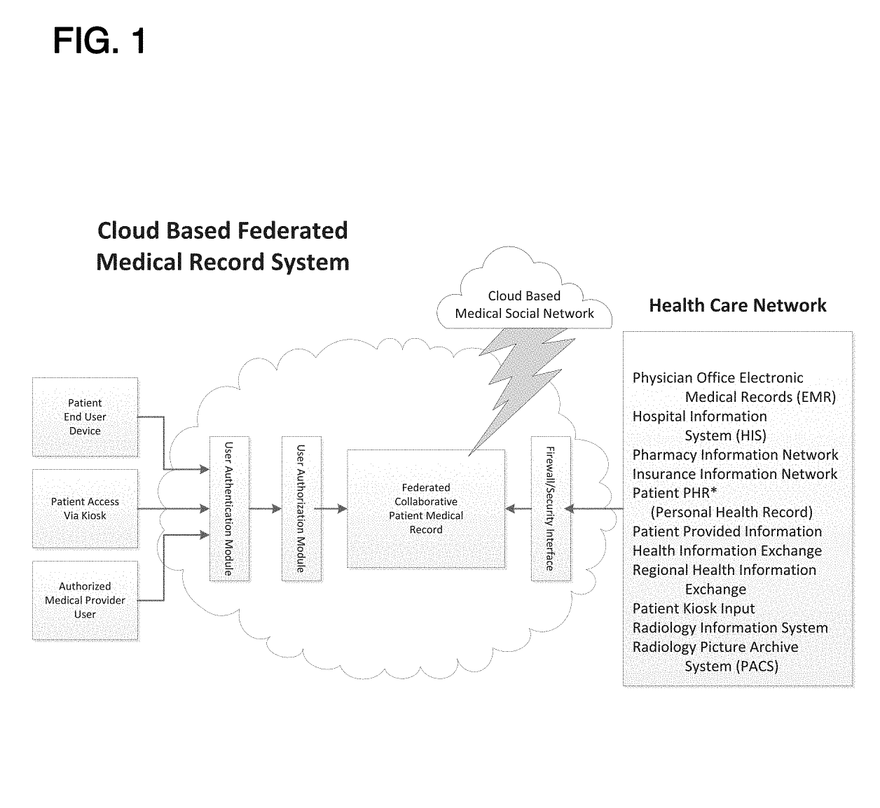

FIG. 2, is a workflow diagram depicting one embodiment of a method of how multiple users might synchronously access the Federated Collaborative Medical Record (FCMR) System.

FIG. 3, is an embodiment of a user interface of the Federated Collaborative Medical Record (FCMR) System displaying a list of radiological images.

FIG. 4 depicts lists of alerts, communications and radiological studies that may be incorporated within an embodiment of the Federated Collaborative Medical Record (FCMR) System.

FIG. 5 depicts a user dashboard that may be displayed within an embodiment of the Federated Collaborative Medical Record (FCMR) System.

FIG. 6 depicts a patient page that may be displayed within an embodiment of the Federated Collaborative Medical Record (FCMR) System.

FIG. 7 depicts an alternative patient page that may be displayed within an embodiment of the Federated Collaborative Medical Record (FCMR) System.

FIG. 8 depicts medical image that may be viewed within an embodiment of the Federated Collaborative Medical Record (FCMR) System.

FIG. 9 depicts an alternative view of a medical image viewer that may be incorporated within an embodiment of the Federated Collaborative Medical Record (FCMR) System.

FIG. 10 depicts a patient home page that may be incorporated within an embodiment of the Federated Collaborative Medical Record (FCMR) System.

FIG. 11 depicts a physician dashboard accessible by a medical professional displaying alerts that may be incorporated within an embodiment of the Federated Collaborative Medical Record (FCMR) System.

FIG. 12 depicts a patient dashboard displaying alerts that may be incorporated within an embodiment of the Federated Collaborative Medical Record (FCMR) System.

FIG. 13 depicts a patient dashboard accessible by a patient summarizing a patient's medical condition that may be incorporated within an embodiment of the Federated Collaborative Medical Record (FCMR) System.

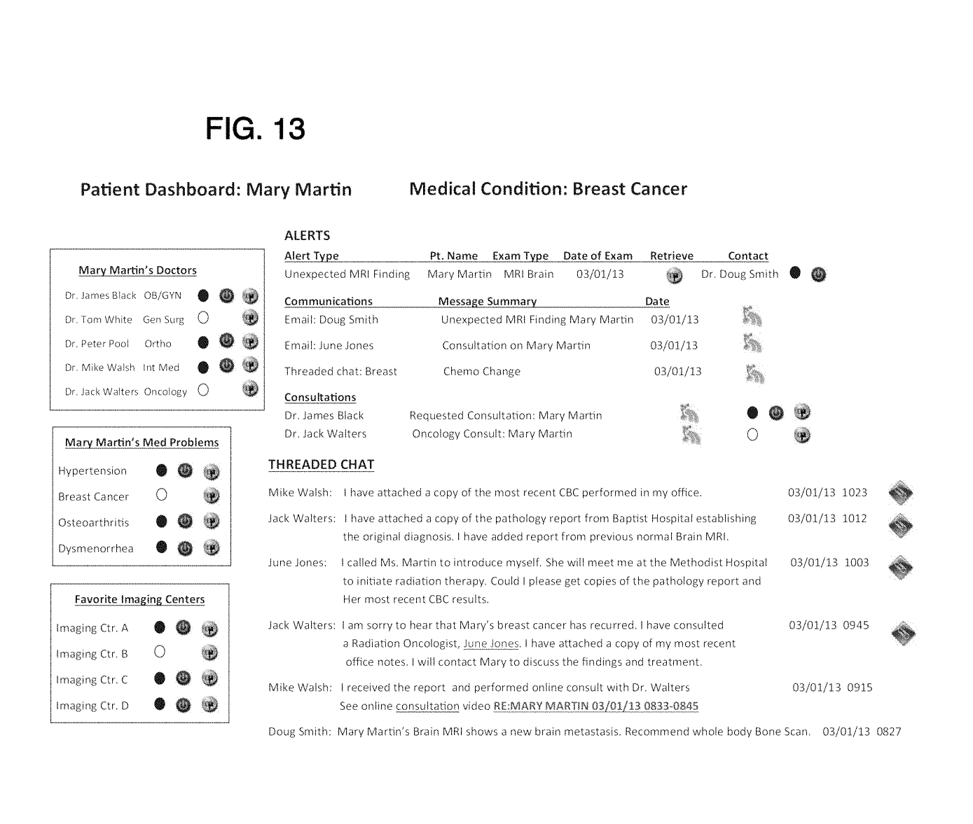

FIG. 14 depicts a transaction log that may be incorporated within an embodiment of the Federated Collaborative Medical Record (FCMR) System.

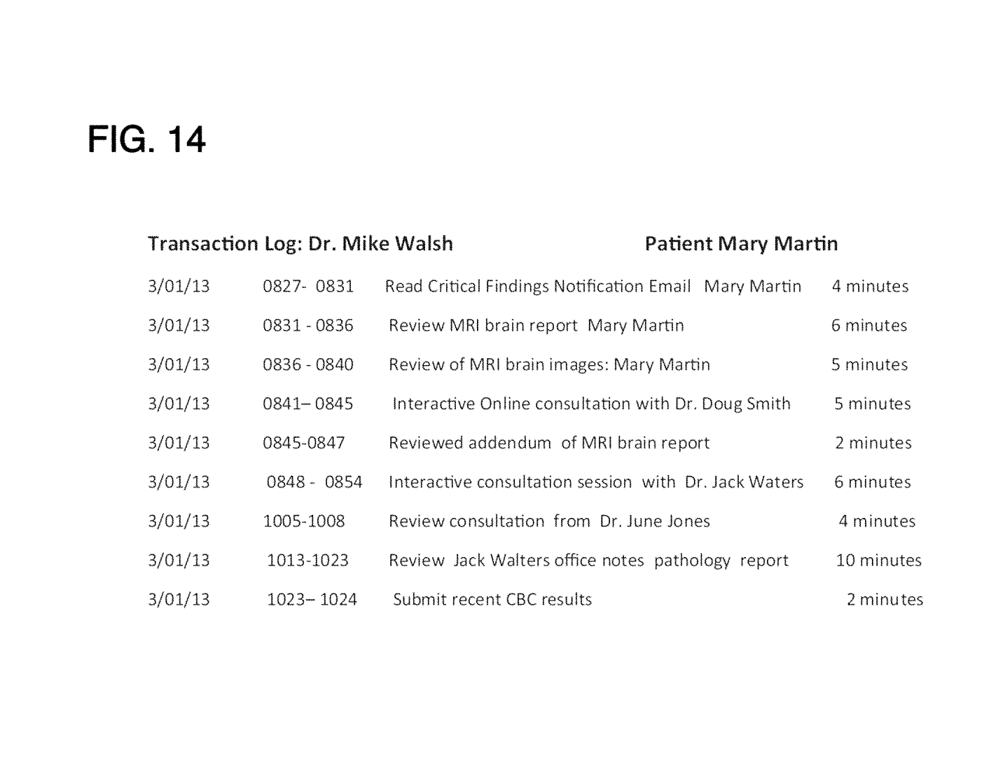

FIG. 15 depicts a patient log that may be incorporated within an embodiment of the Federated Collaborative Medical Record (FCMR) System.

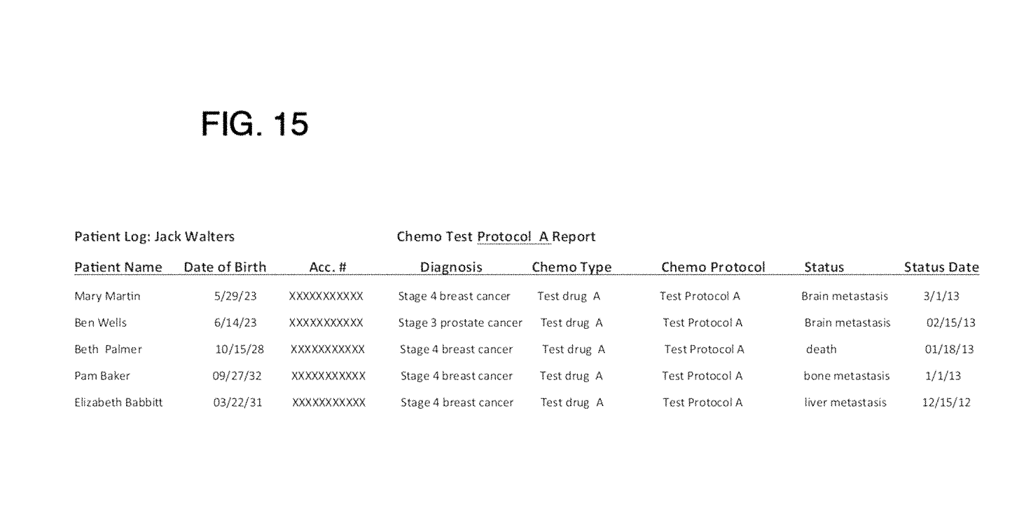

FIG. 16 depicts a critical findings notification log that may be incorporated within an embodiment of the Federated Collaborative Medical Record (FCMR) System.

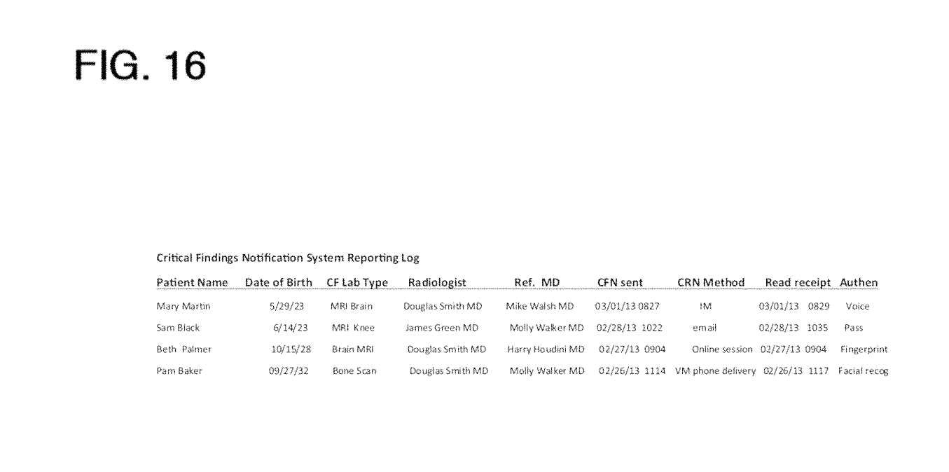

FIG. 17 depicts an alternative physician dashboard accessible by a medical professional that may be incorporated within an embodiment of the Federated Collaborative Medical Record (FCMR) System.

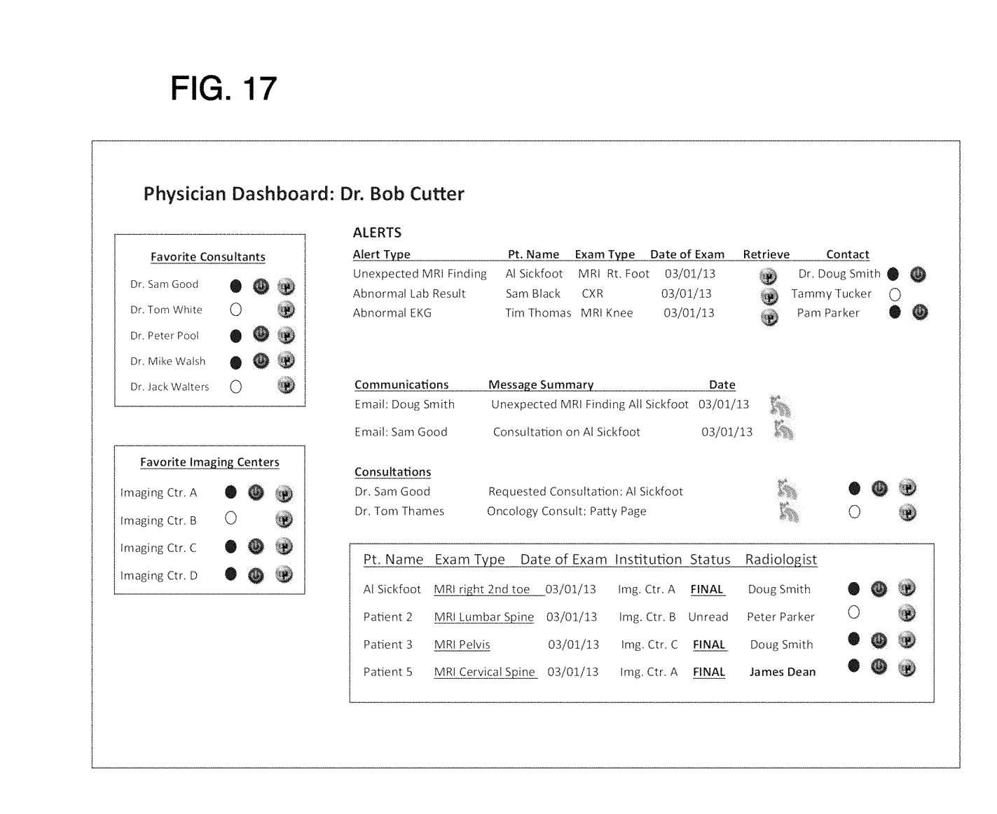

FIG. 18 depicts an alternative patient dashboard accessible by a patient that may be incorporated within an embodiment of the Federated Collaborative Medical Record (FCMR) System.

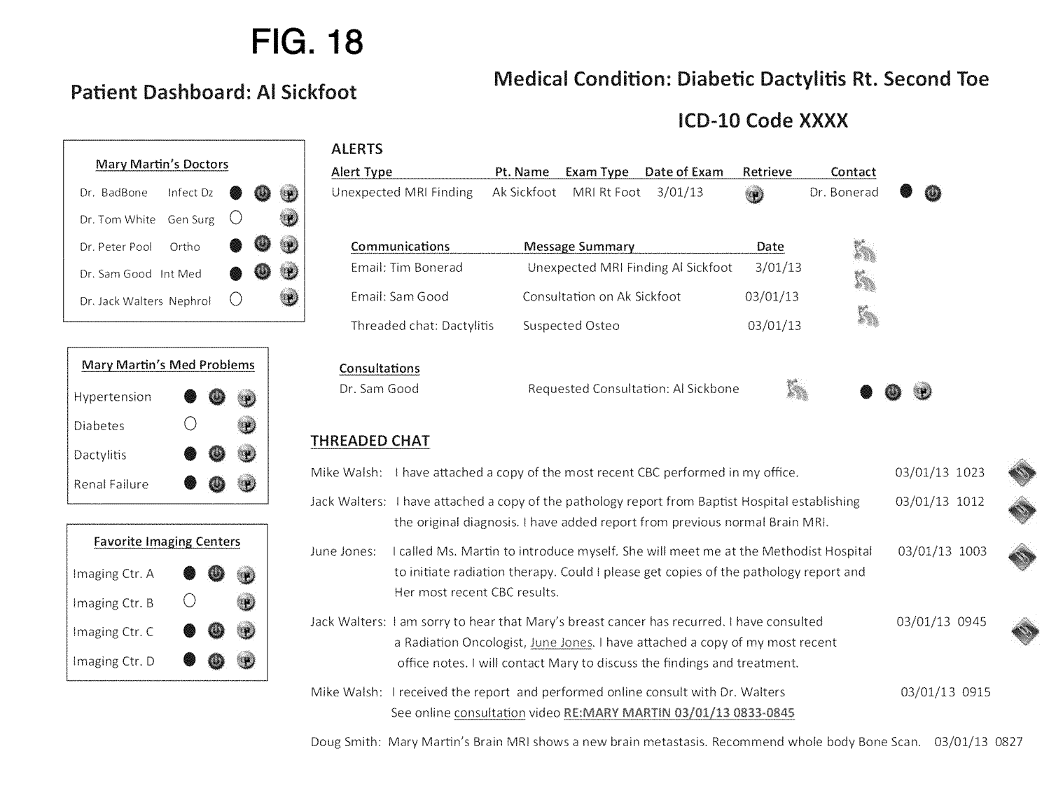

FIG. 19 is a workflow diagram demonstrating how multiple users might collaborate by utilizing the Federated Collaborative Medical Record (FCMR) System.

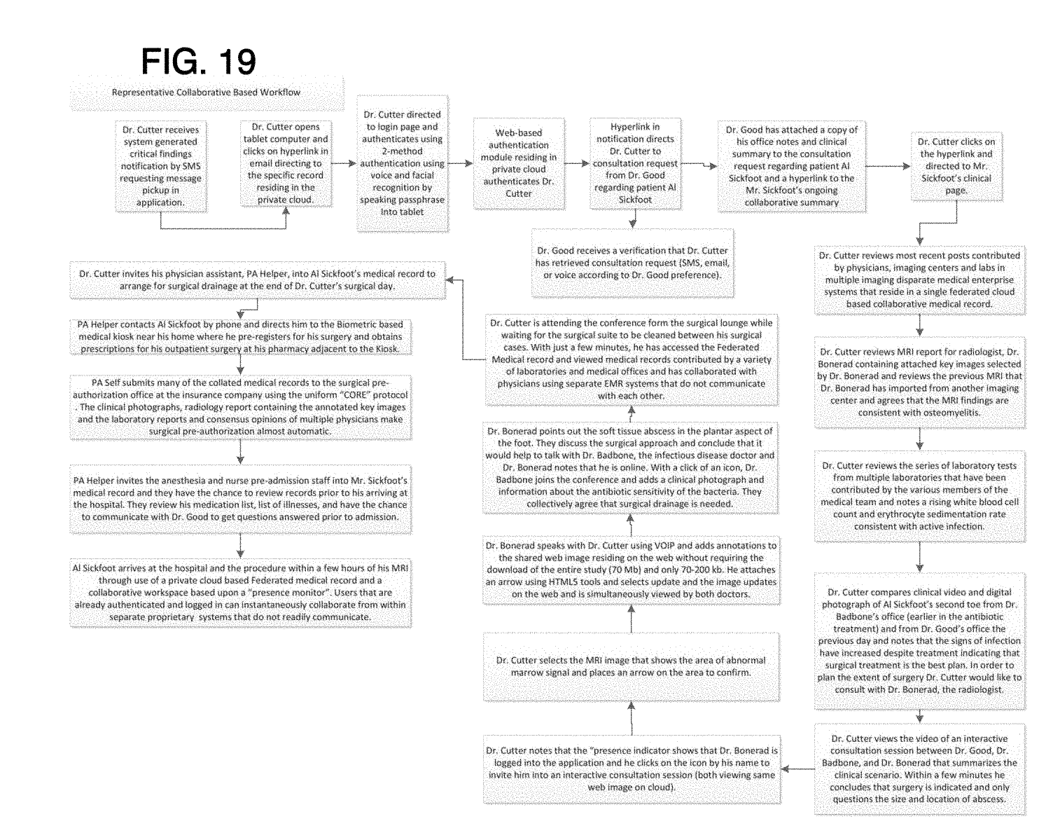

FIG. 20 depicts an alternative patient dashboard accessible by a patient highlighting a complications sub-menu that may be incorporated within an embodiment of the Federated Collaborative Medical Record (FCMR) System.

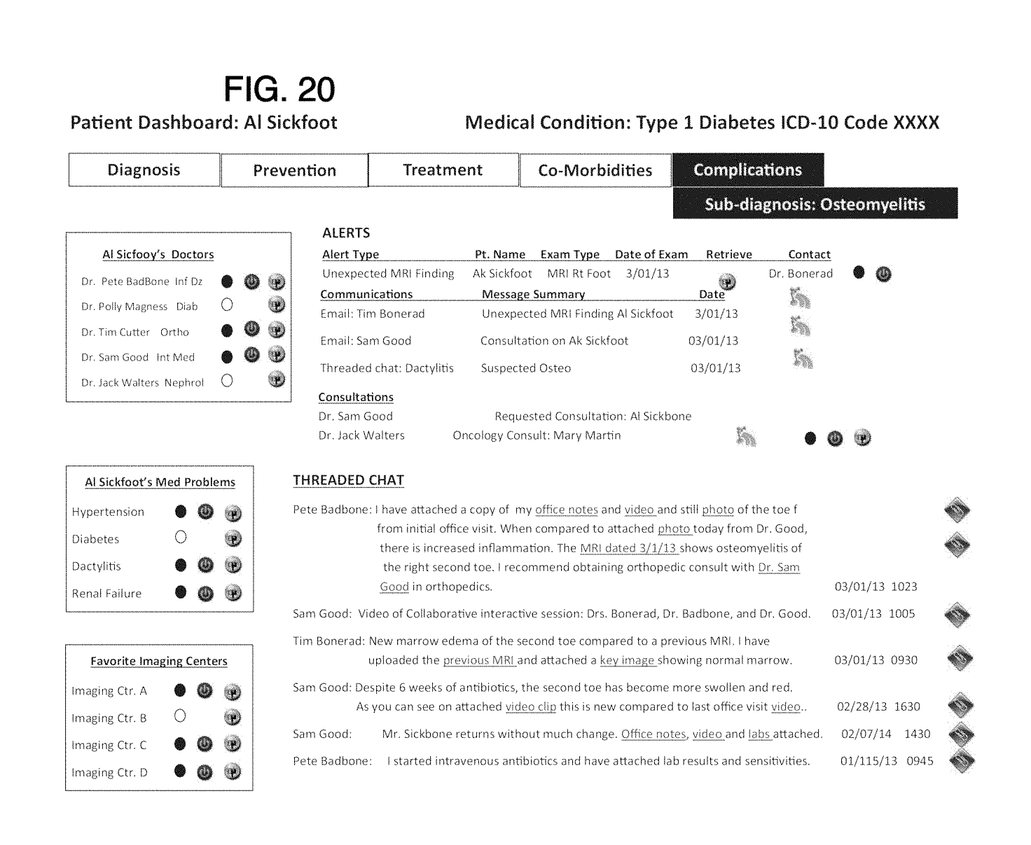

FIG. 21 depicts an alternative patient dashboard accessible by a patient highlighting a treatment sub-menu that may be incorporated within an embodiment of the Federated Collaborative Medical Record (FCMR) System.

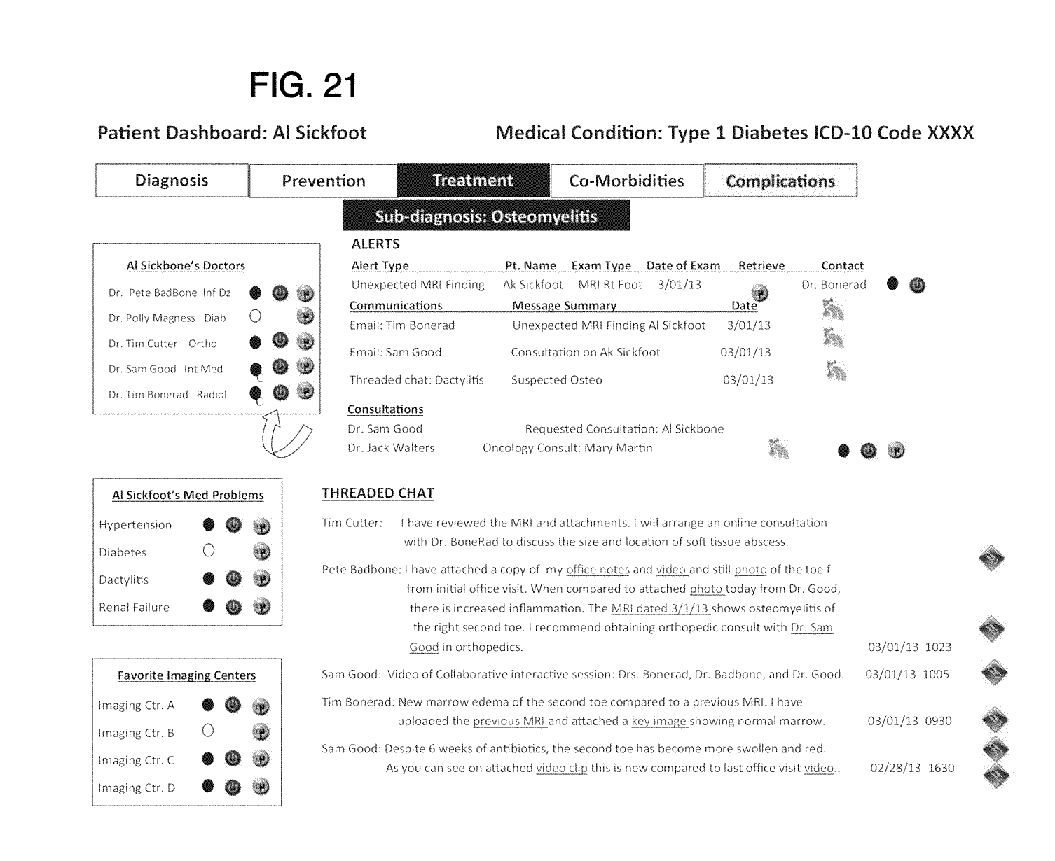

FIG. 22 is a pictorial workflow diagram demonstrating how multiple users might collaborate by utilizing the Federated Collaborative Medical Record (FCMR) System.

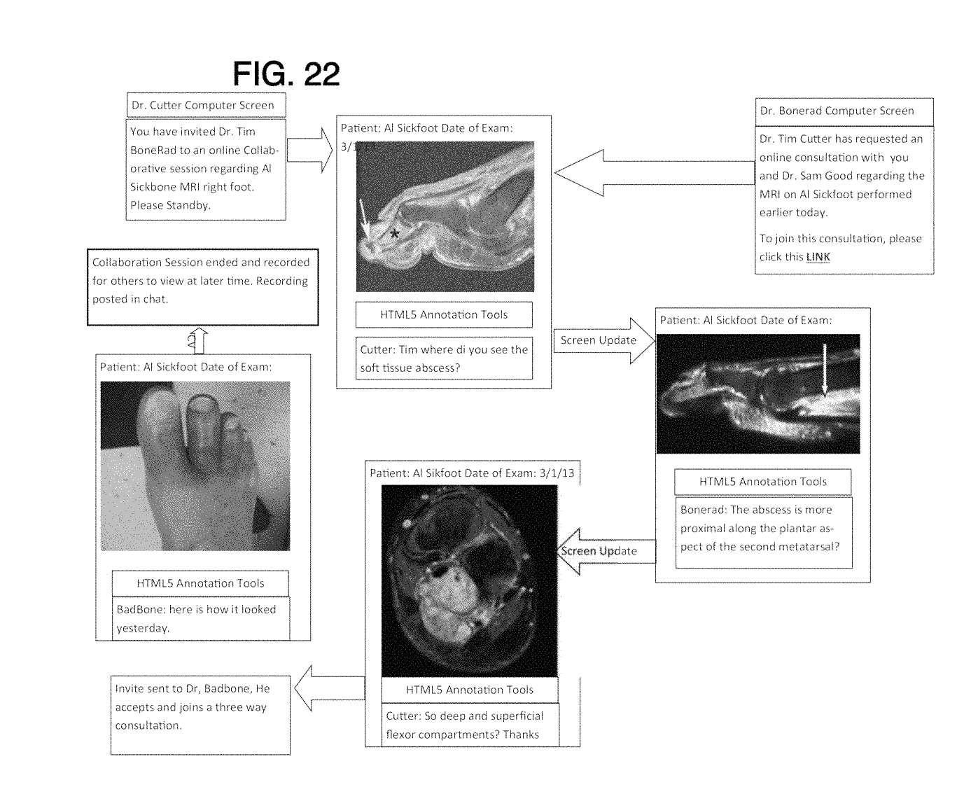

FIG. 23 is a workflow diagram demonstrating how the Federated Collaborative Medical Record (FCMR) System may incorporate Application Program Interfaces (APIs).

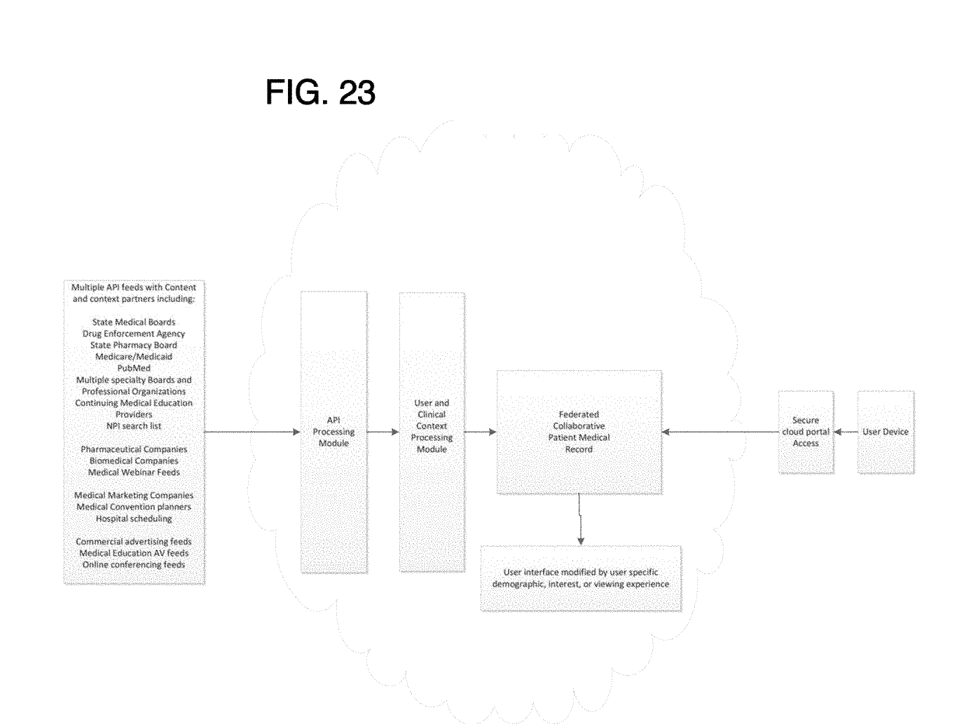

FIG. 24 is a workflow diagram demonstrating how information might flow through to a Physician Landing Page in an embodiment of the Federated Collaborative Medical Record (FCMR) System.

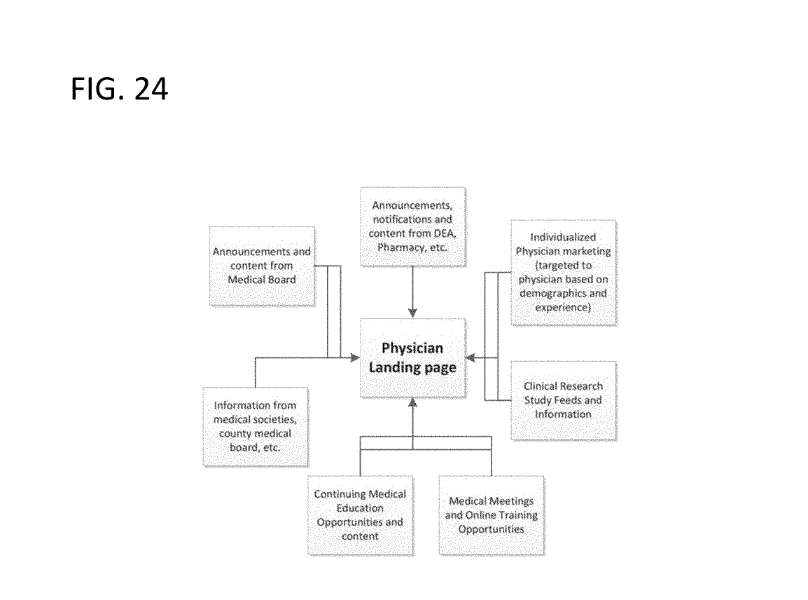

FIG. 25 is a workflow diagram demonstrating how information might flow through to a Patient Landing Page in an embodiment of the Federated Collaborative Medical Record (FCMR) System.

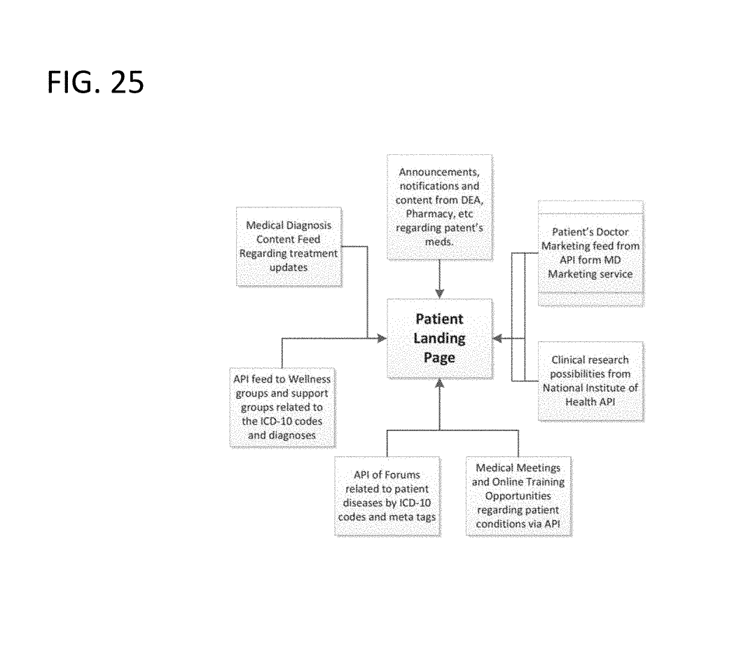

FIG. 26 is a workflow diagram demonstrating how information might flow through to a Medical Diagnosis Page in an embodiment of the Federated Collaborative Medical Record (FCMR) System.

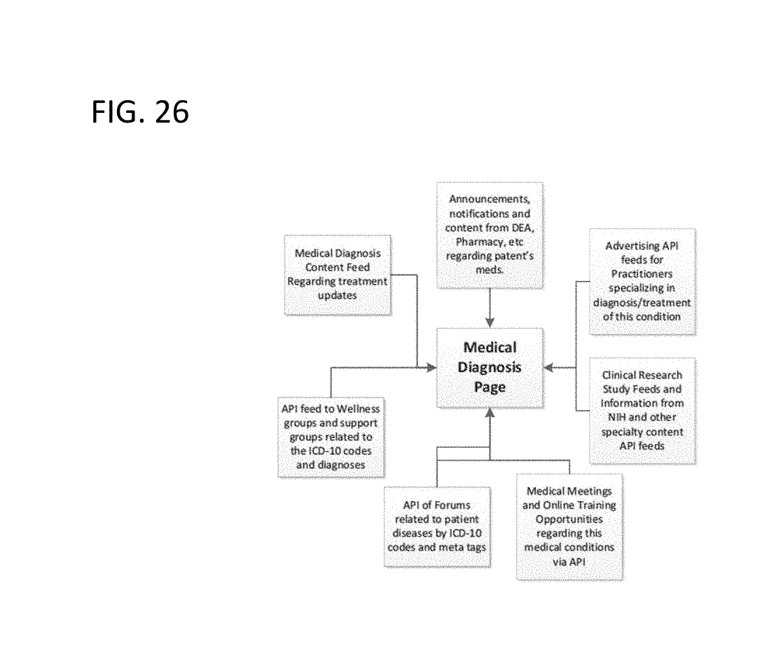

FIG. 27 is a workflow diagram demonstrating how information might flow through to a Medical Assistant Page in an embodiment of the Federated Collaborative Medical Record (FCMR) System.

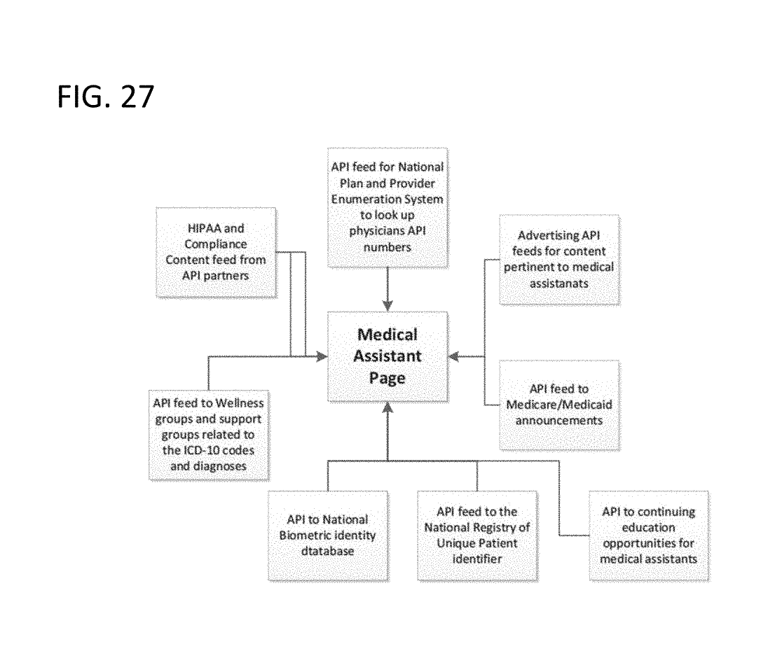

FIG. 28 is a workflow diagram demonstrating how information might flow through to a Technologist Page in an embodiment of the Federated Collaborative Medical Record (FCMR) System.

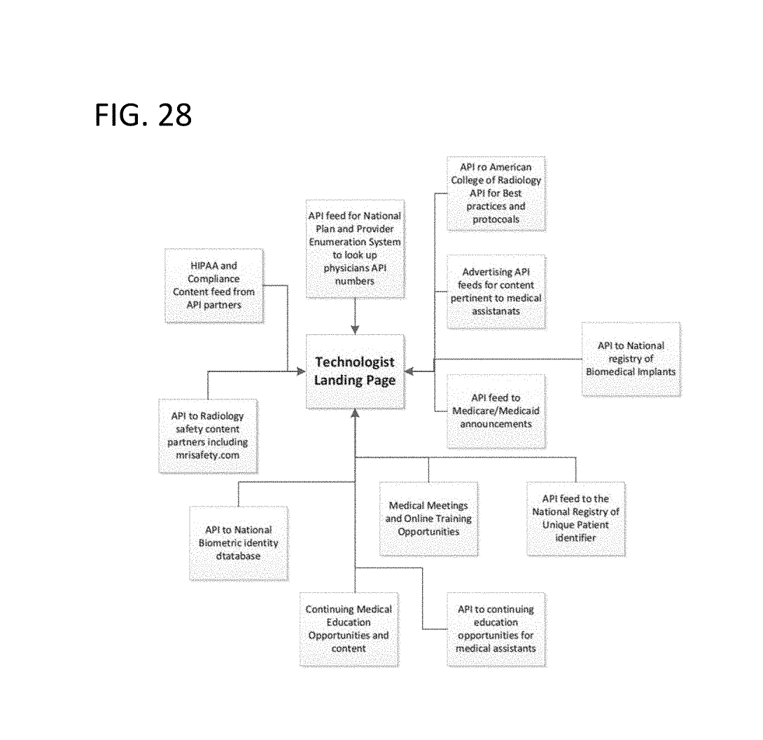

FIG. 29 is a workflow diagram demonstrating how information might flow through to a Patient Portal Landing Page in an embodiment of the Federated Collaborative Medical Record (FCMR) System.

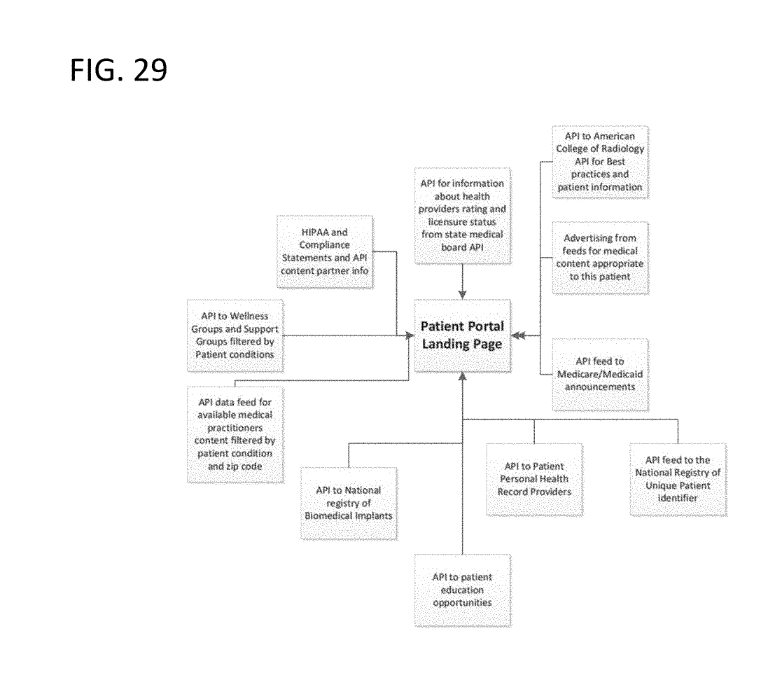

FIG. 30 is a workflow diagram demonstrating how information might flow through to a Imaging Center Page in an embodiment of the Federated Collaborative Medical Record (FCMR) System.

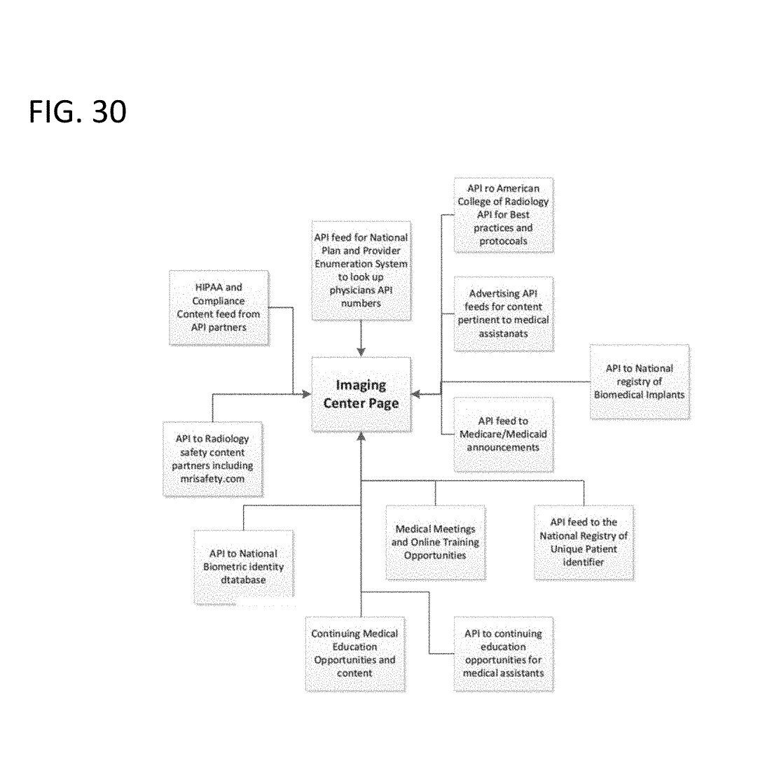

The apparatus and method components have been represented where appropriate by conventional symbols in the figures, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well understood elements that are useful or necessary in a commercially feasible embodiment may not be depicted in order to facilitate a less obstructed view of these various embodiments.

### DETAILED DESCRIPTION

The core of the cloud based application is the federated collaborative patient medical record is a physician centric, database containing information contributed from a number of sources including contributions that individual medical practitioner users believe would be useful for other medical practitioners for the care and treatment of their patients. Data may also be obtained from a variety of medical networks including, but not limited to: numerous independent electronic medical records (EMR) systems, hospital information system (HIS), pharmacy information network, insurance information network, patient personal health records (PHR), patient provided information, health information exchange (HIE), regional health information exchange (RHIO), patient kiosk input (described in a separate filing entitled: A Meaningful Use-Compliant, Single Login, Federated Patient Portal System and Methods U.S. App. Ser. No. 61/799,613 (Filed 15 Mar. 2013), radiology information system (RIS), picture archive and communication systems (PACS). The input of data is controlled by firewall device and a system of token based security as a service that has been described in a previous filing entitled an ePHI-compliant gatekeeper system and methods invented by Douglas K. Smith, M.D., Ser. No. 13 555,164 (filed Jul. 22, 2012). The federated medical record also accepts input from a cloud based medical social network that provides subjective quality measures of health care performance using a methodology described in a previous filing U.S. patent application Ser. No. 13/354,219 (19 Jan. 2012).

An appropriately authorized end user can access the FCMR cloud using a variety of end user devices or “user equipment” (including personal computers, tablet computer, SmartPhone, mobile devices, Kiosk access, or access through a secure medical network). The user accesses the secure web portal and interacts with the user authentication module. Users interface with a cloud based “User authentication module” providing an apparatus and methodology for validation of the identity of the user using a variety of methods (for example among others a login and password, dual method authentication using biometric methods such as voice recognition, facial recognition, fingerprint, retinal scanning, iris scanning or hand vein recognition). If the user is successfully authenticated by the “user authentication module”, the “User authorization module” is a device for assuring that the user is properly authorized to access the medical records of individuals. The functionality of this “user authorization module” has been described in previous filing entitled an ePHI-compliant gatekeeper system and methods invented by Douglas K. Smith, M.D., Ser. No. 13 555,164 (filed Jul. 22, 2012). Subsequent figures will demonstrate the range of information dashboards that are accessible to an authorized user. A properly authorized user will have access to Cloud Based Medical Social Network and Database.

Prior to this disclosure, a physician must interact with multiple patient records maintained in multiple proprietary record stores. The ARRA (American Recovery and Reconstruction Act) provided financial incentives for physicians to adopt “meaningful use” of electronic medical records (EMR). In order to qualify for meaningful use incentive funds, a physician must choose one of a multitude of qualified EMR systems and meet utilization standards. Unfortunately, most of these software solutions have been constructed rapidly to meet regulatory requirements and to differentiate from industry competitors.

Most physicians complain that EMR systems facilitate sharing of medical records between medical providers within a single medical entity and sharing the same EMR system. There is no existing, feasible method for physicians and medical providers to collaborate, share records, obtain consultations, or participate in simultaneous versus asynchronous teleconferencing between medical entities with disparate EMR systems. Although EMR systems can connect using network integration tools such as HL7, the establishment and maintenance of these integration methods are expensive to establish and it is not cost-effective for medical entities to connect to the plethora of medical facilities and physician offices with whom a physician interacts. Many large medical providers and enterprise health networks express concerns about granting access to their database relating both security and proprietary business concerns. The meaningful use incentives have dramatically increased the number of digital medical records but without a feasible method of sharing records between physicians except those in enterprise level organizations.

In some areas, health information exchanges (HIE) have been created to facilitate data exchange although many physician users complain that the user access and HIE data formatting is not designed for how physician's practice medicine and generally suffer from the “big data” problem. It is similar comparison of a classic library compared with an online “book club” chat room for handling data. In the classic library one cannot check out a book unless one has an approved library card. If drives to the library and checks out the book and drives home, reads the book and then drive to the appointed time and place for the weekly book club meeting. One cannot communicate with other book club members except in very specified manner of time and space and if someone references another book, nobody else has access to the book without driving to the library. The current correlate would be that a physician gets a FAX report of a laboratory result and decides that the patient needs to see a consultant physician although the two physicians do not use the same EMR system. The first physician calls the second physician to arrange for a consultation. FAXable records may be FAXed while medical records such as radiology images and reports are hand carried to the second physician's office. In many cases, the format of the CD containing the images is also proprietary and may be locked or incompatible with the physician's computer system. In this case, the patient is asked to obtain films form the imaging center that produced the study. These films must be obtained, transported and archived. The other dysfunctional solution to diagnostic imaging systems is to ask physicians to separately subscribe to PACS systems. Physicians don't have the time or interest in remembering 10 different login credentials and domains or learn a dozen different, conflicting tools sets.

What is needed is a medical equivalent of a cloud based book club that is provided in this instant disclosure. As long as one has a computer, one can read the book, import reference material, seek opinions from others, participate in a real time chat about the book, and leave messages for other book club members, as well as other collaborative methods regardless of whether one uses a MacIntosh or PC; or operating system is Windows, Apple, or Android. The term “cloud computing” in this application and appended drawings refers to computing models for enabling network access to a shared pool of configurable computing resources, such as among others networks, servers, storage, applications, and services. The terms “cloud-based”, “cloud computing”, “cloud” in this application and appended claims refers to computing models for enabling network access to a shared pool of configurable computing resources, such as among others networks, servers, storage, applications, and services.

Most patients do not restrict their medical team to one medical system and one proprietary EMR. As a result, most physicians have need for an open source collaboration method without the proprietary obstacles that exist between EMR systems. Physicians' need a system where they can access a cloud based federated database of medical information that can be accessed by each of the patient's physicians can access the patient's records and collaborate, share only those records pertinent to the medical condition or problem being discussed and quickly and efficiently collaborate. This disclosure will describe how this can be accomplished.

During the past 3 years there has been a frantic rush for physicians and medical facilities to adopt one of a plethora of certified electronic medical record systems. Unfortunately, the disparate EMR systems were built quickly to separate their product from competitors and to capture large corporate clients generally using entries systems. Seamless collaboration between physicians using different EMR systems was never a goal for these proprietary EMR systems. Governmental initiatives have been divided amongst various governmental entities and although there has been some progress toward establishing a universal communication standard, there is exists no communication method for physicians using different EMR and diagnostic imaging systems to communicate with each other and collaborate online in a real-time seamless manner.

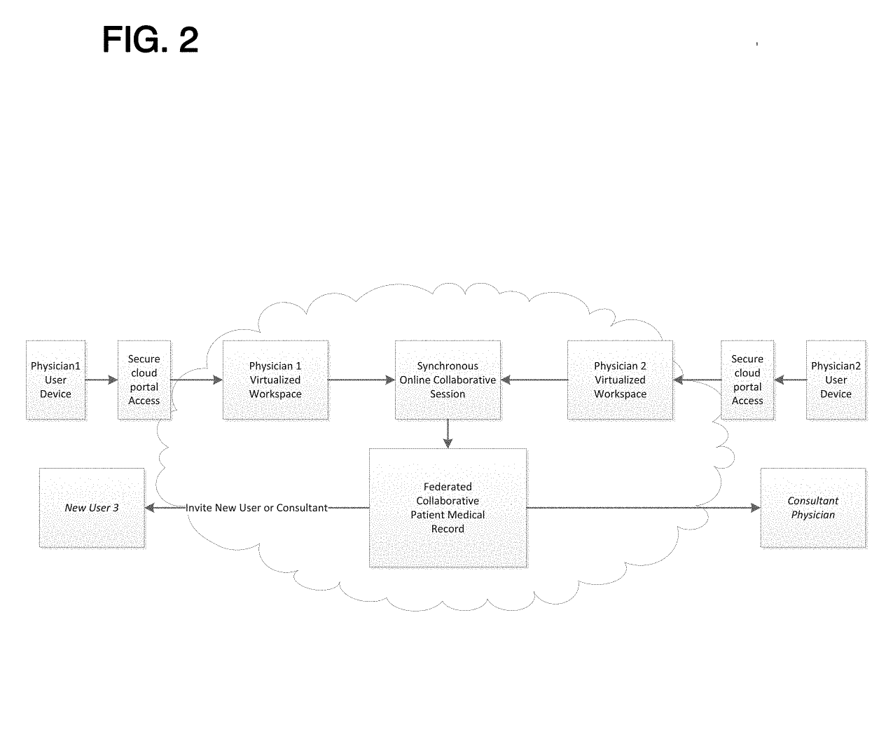

FIG. 2 demonstrates a diagrammatic representation of a federated collaborative patient medical record system and method for an physician to access a personalized virtual workspace by accessing a secure web portal access. The personalized workspace or “physician dashboard” contains the physician's most commonly used or “favorite” physician colleagues, radiologists, and imaging centers. The physician's dashboard collates information form the entire database and gathers the most recent or clinically relevant medical information on one easily accessible page. Prior to this disclosure, the physician may have to access a dozen physician portals to access this same information and may remain unaware of clinically pertinent information residing on medical networks that he does not access. In a previous application, I described how a token based synchronization as a service module could be used to synchronize the information between participating systems.

The core requirement is a physician dashboard where the physician user can view his urgent notifications, updates on radiology or laboratory finding on his patients, secure email from colleagues and view the most recent imaging studies or laboratory results of his patients. This dashboard page includes a listing of the physician's “Favorite” consultant physicians including a designation of whether this consulting physician is currently online. If consulting physician is currently online, physician can initiate a real time, online collaboration session with the consultant with a click of an icon. A unique and critical component of this disclosure is a process for ascertaining that users are currently logged into the application and methods for conveying to other users that a user is currently logged in. This presence monitor solves one of the greatest causes of inefficiency in medical communications, determining when two busy physicians are available for communication and facilitating the communication process. Because both users are already logged into the cloud based system, there is no need for the time consuming process of authentication and authorization and the two physicians are viewing the same screen and patient records within seconds.

If the other recipient physician or user is not online, a user can write a secure email to the recipient that resides only within the system. No electronic protected health information (ePHI) leaves the network. A system generated email or SMS is delivered to the recipient notifying him that there is a message to be picked up on the FCMR and the ePHI is retained within the security of the network and viewed online using the web application. The system generated notifications are the only communications leaving the system and they do not contain any protected health information. When the recipient physician retrieves the email, the sending physician receives a receipt notification if desired.

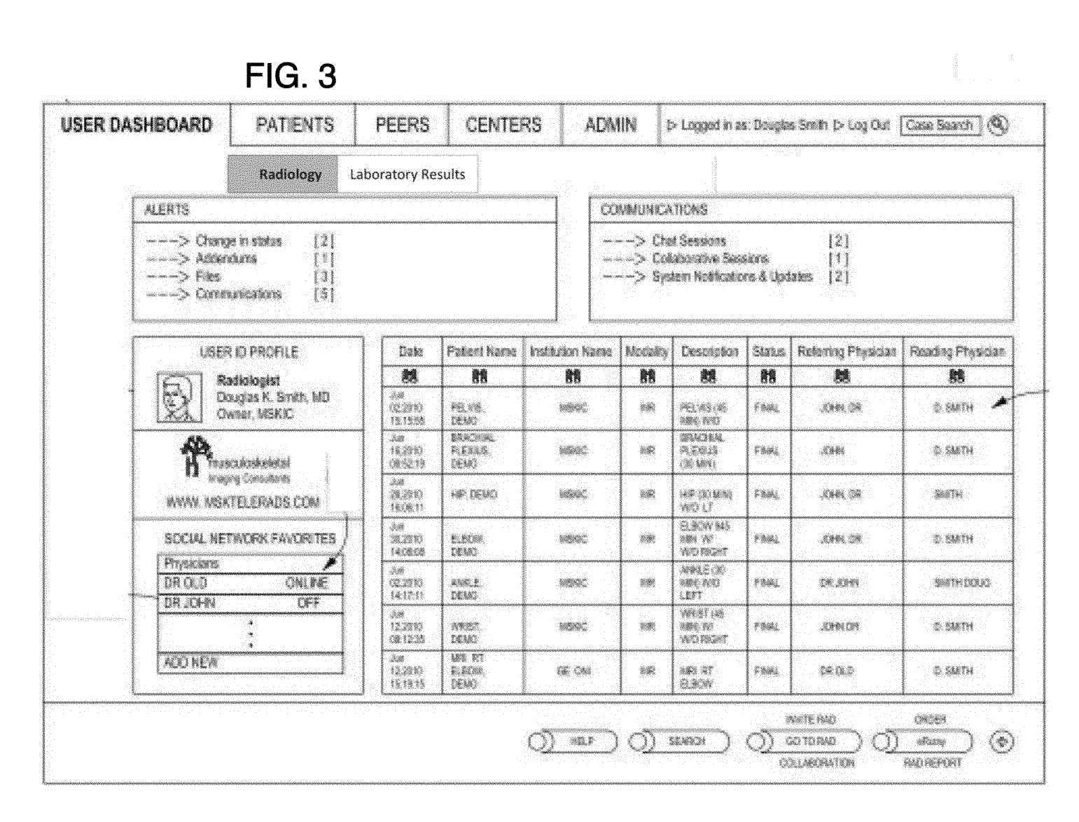

FIG. 3 demonstrates one example of a physician dashboard where the most recent or clinically relevant information is gather for the user into a single workspace, The workspace is divided into an “Alerts” section, a “Communications” section, a user profile and preferences section, a recent imaging studies and laboratory results section, and a “Utilities” section. In the “Alerts” section the user retrieves a variety of clinically important notifications including critical findings notifications, changes in status of patients or radiology or laboratory results. On the dashboard, the physician can view his electronic communication (e.g. email or instant messages (IM)) and can view the most recent posts in the chat posts regarding patients or topics to which physician has subscribed and is authorized to view. The critical findings notification system notifies the recipient by sMS, phone, email that there is message to pick up within the system (most likely from somebody in need of contact regarding a pending issue). Therefore, when user logs in a synchronous collaboration can be performed. The system van notify a user by IM or SMS when a user logs in.

The dashboard page also includes a listing of the physician's favorite imaging centers where he can place an electronic order more radiology studies or place an order for laboratory testing. Alternatively, the physician can use a dynamic “on-the-fly” filter to search for the imaging center that meets any combination of designated requirements including zip code, imaging modality, quality rating by other patients, desired time of day, insurance carriers accepted, rating of the radiologist, etc. The physician or patient can select the imaging center that best meets his or her needs and electronically place an order for studies. This dynamic or “on-the-fly” filter functionality has been previously described in a previous filing U.S. patent application Ser. No. 13/354,219 (19 Jan. 2012). The user can access other dashboard presentations using a series of tabs.

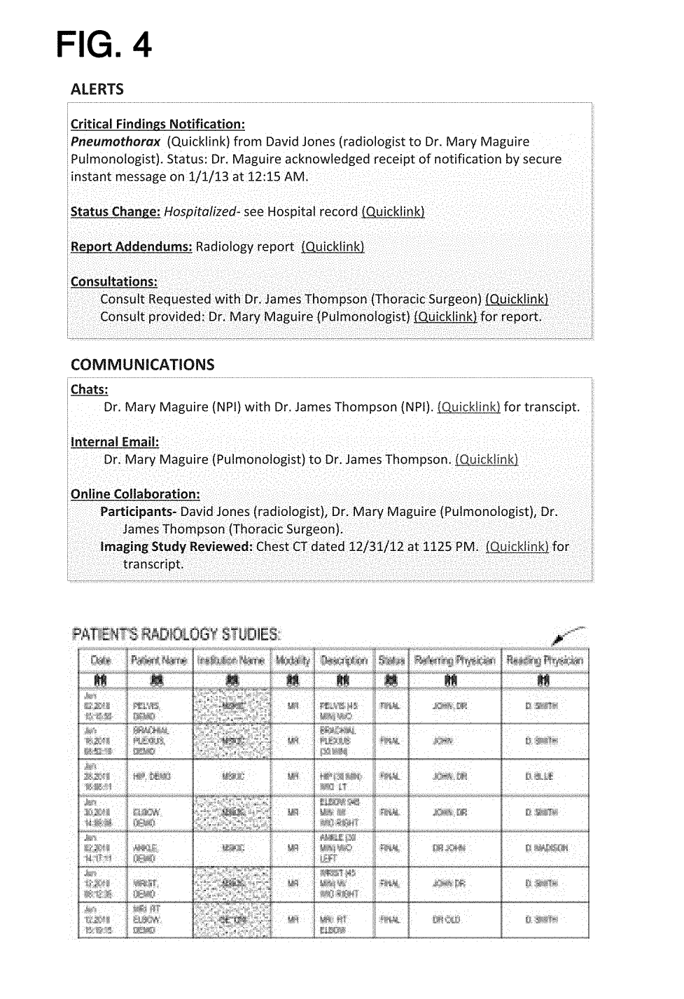

FIG. 4 is a detailed representation of the “Alerts” section and the “Communications” sections and “Radiology Reports” sections. This figure lists the types of alerts and communications that can be accessed in plain sight on the top of the dashboard. The radiology reports section lists the physician's 20 most recent radiology reports from a variety of participating imaging centers,

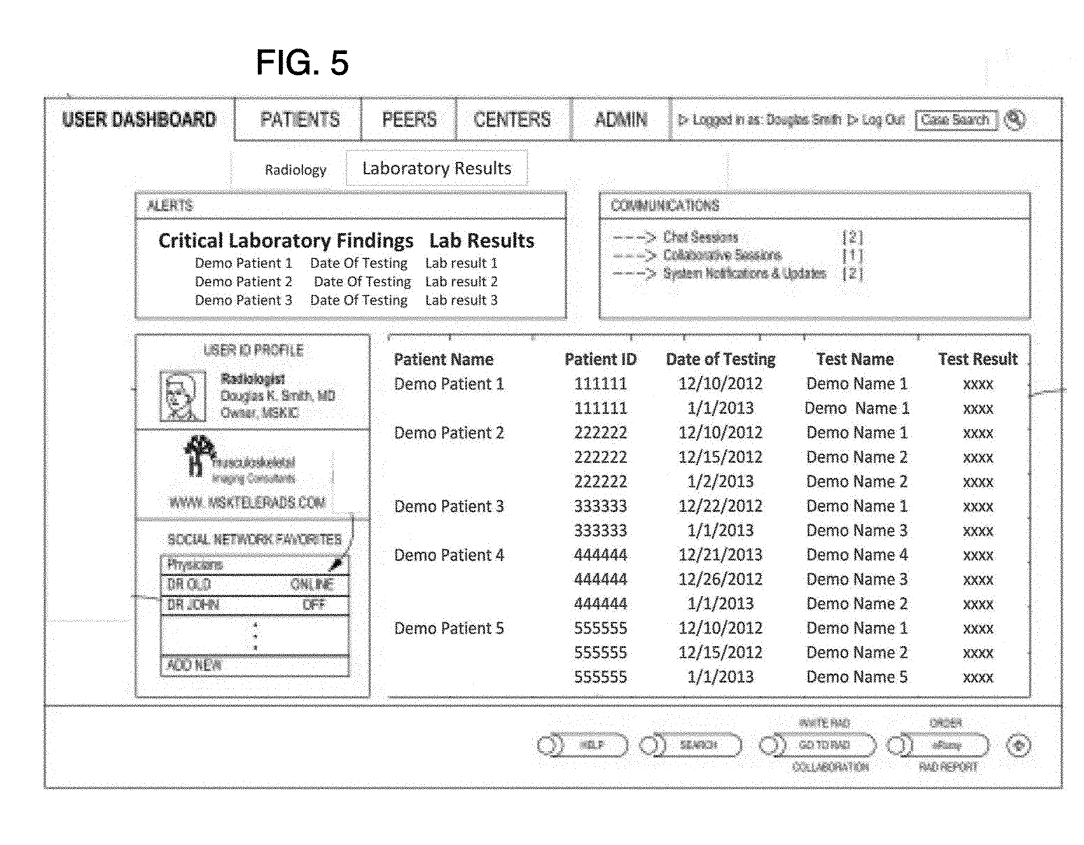

FIG. 5 shows the contents of a laboratory dashboard page where the physician can view “alerts” pertaining to laboratory test results, “communications” related to the laboratory results and a listing of the most recent 20 laboratory tests ordered by the physician.

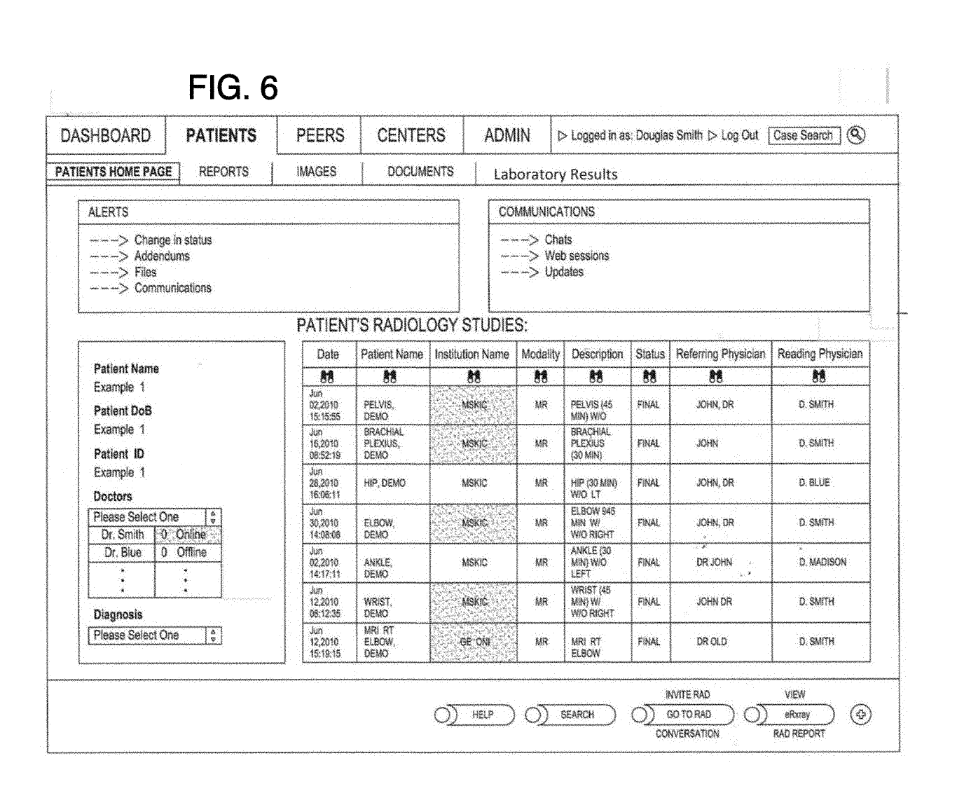

FIG. 6 shows the “Patient Dashboard” that presents the data relating to a specific patient. This patient dashboard collates and presents the most clinically useful data about a patient in one single dashboard or summary page. The patient dashboard lists the patient's doctors, the patient's medical conditions, medications, and a listing of the patient's diagnostic imaging studies from a variety of centers and results of a patient's laboratory testing. This dashboard page lists emails, IMs, and chats regarding this patient's medical care. A physician could catch up on a patient's medical care by reading a threaded chat regarding this patient's care. A physician can also request a consultation with another physician into the patient's care team or post an office note or other outside medical record for sharing by the collaborating medical team. A physician could access summary information about how the patient rated the physican's care at various medical facilities from the information gathered from the social media medical network described in a previous application.

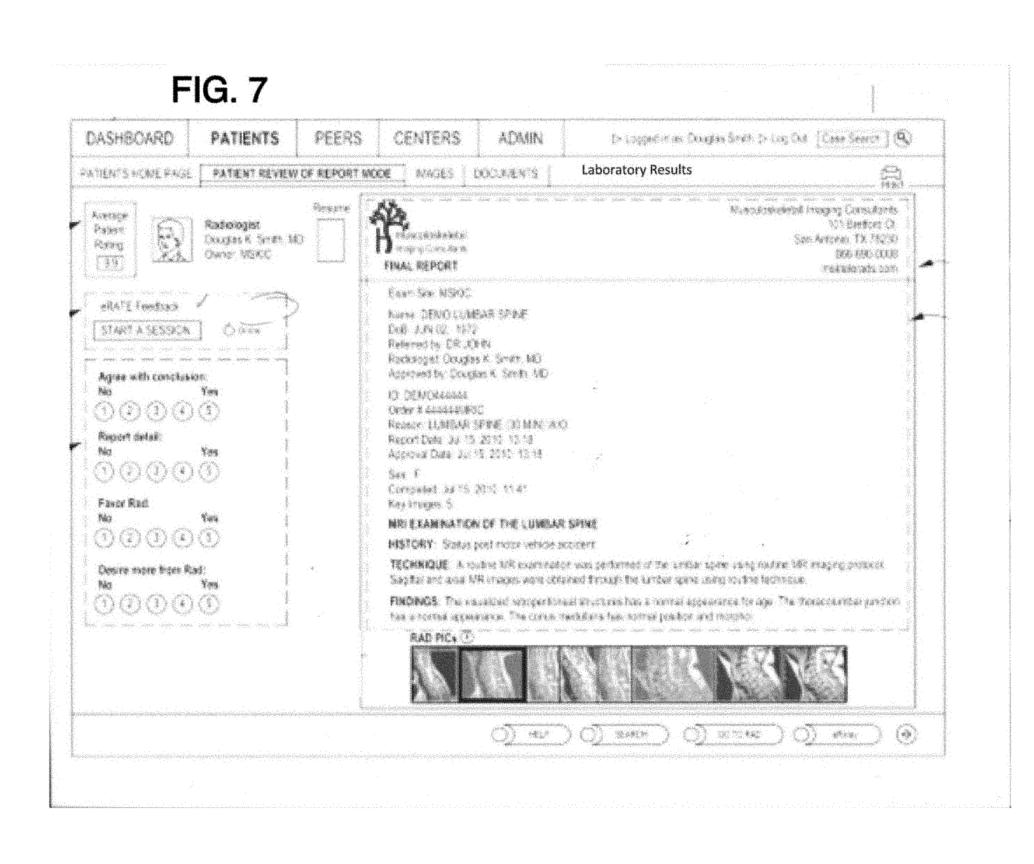

FIG. 7 shows a “report review” page that shows the radiology report with annotated key images that should the salient findings described in the repot. This report page shows information about the radiologist that read the study including a biographic description and curriculum vitae or CV. There is also an eRate® section that allows the user the opportunity to provide a subjective rating of the content and style of the radiology report generated by the radiologist. This information is used to provide feedback to the providers and as a method for filtering the case distribution so that this user's cases are distributed to imaging centers and radiologists that are most to the user's liking Each of the pages have a “Utilities” section where there are applications proving help function, search function, online collaboration feature and electronic ordering of radiology or laboratory studies.

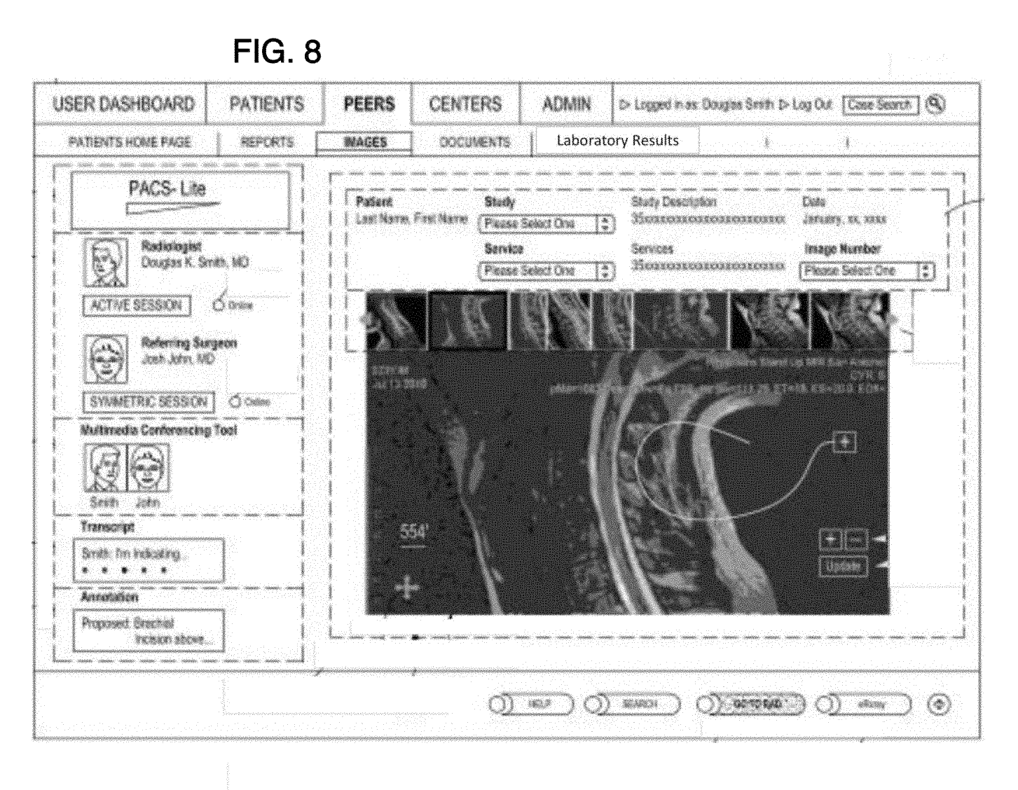

FIG. 8 shows a DICOM viewer to be used to screen the findings and not meant for diagnostic purposes. This simple DICOM viewer contains very simple tools so as to be intuitive to use and not as intimidating as full data sets. This DICOM viewer is most commonly used to view the images identified by the radiologist as being the most pertinent or representative of the patient's medical illness.

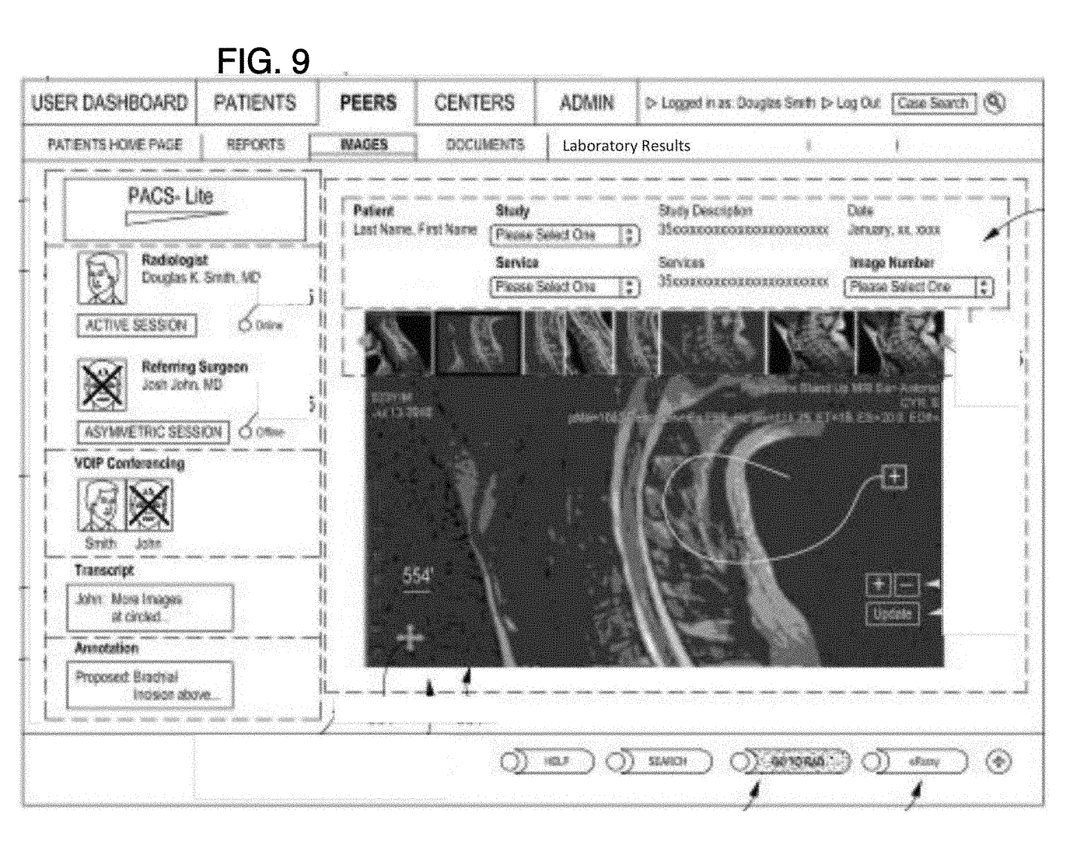

FIG. 9 shows the content of a “physician dashboard” page. As described in FIG. 3, the physician dashboard page has “alerts”, “communications” and “consultations” segments. The clinical examples described below show how this dashboard information can be useful. The dashboard lists the physician's favorite colleague physicians and lists whether the physician is currently online (using the presence monitor). The favorite imaging centers section also shows whether an imaging center representative is currently online.

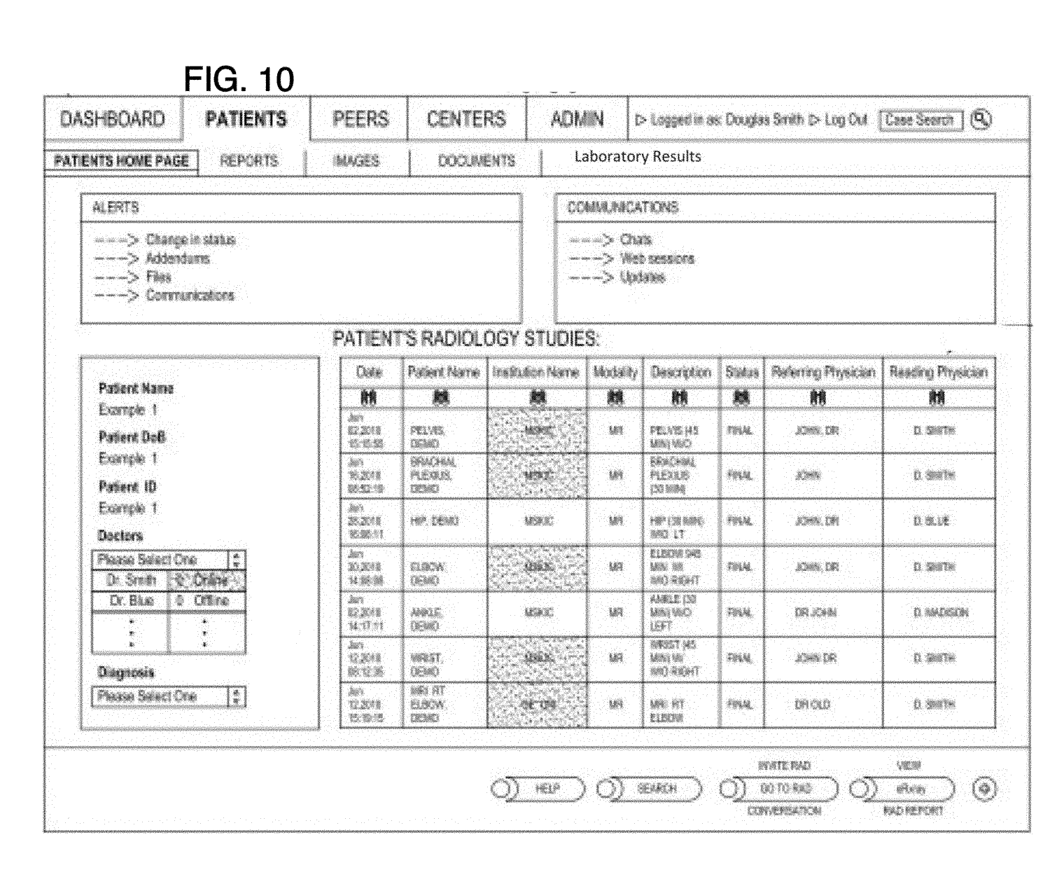

FIG. 10 shows a patient dashboard page of a fictitious patient named “Mary Martin”. The dashboard lists the Mary Martin's doctors, her medical conditions, and her favorite imaging centers. To the right of the doctor's name is a designation of whether the doctor is currently online. If the physician is offline the presence monitor designation has an empty or white circle. If the physician is online, the circle is black and there is a selectable hyperlink icon that initiates an online collaborative session with the user. The third icon hyperlink initiates a secure internal email communication with the physician. Similar icons are present along the right side of the radiology reports as designation of whether the radiologist that read the study is online and available for an online consultation. Another icon allows a user to download documents or consultation requests.

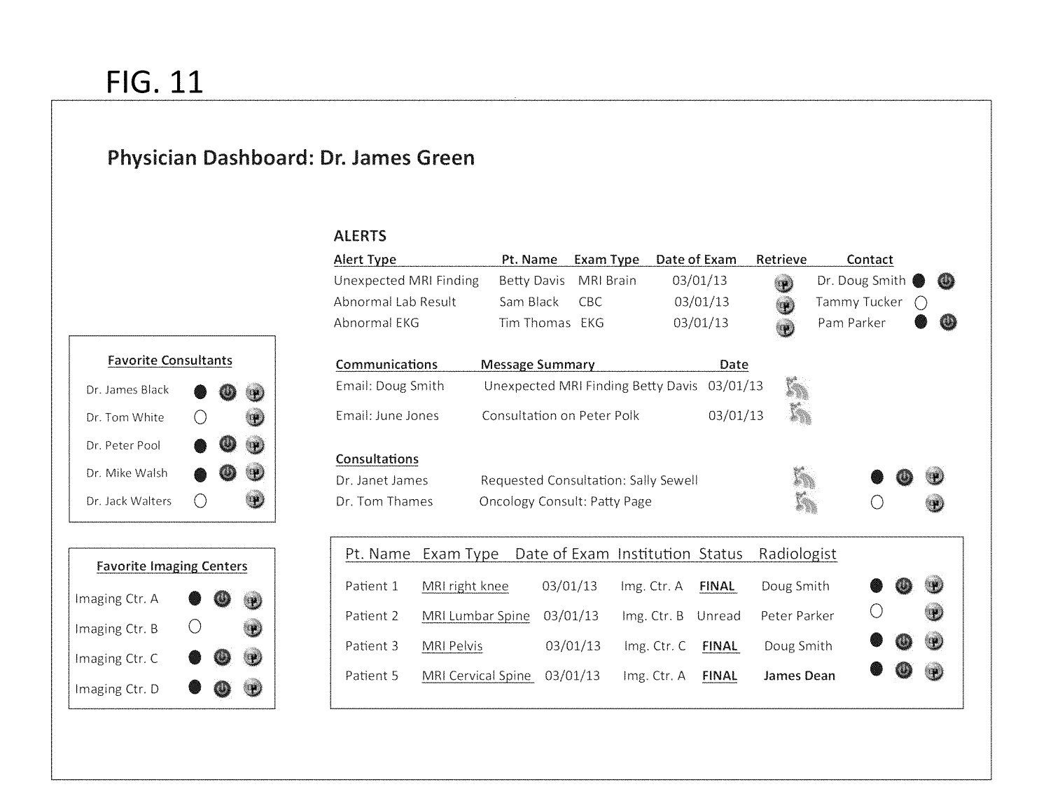

FIG. 11 shows a subcategory, medical condition page for Mary Martin's breast cancer condition. When a user is viewing Mary Martin's dashboard page, he can select on the medical condition “Breast cancer” and he is taken to a subcategory page where all the medical information is related Mary Martin's breast cancer. The physician's participating in care of Martin's medical care are listed on this page. The alerts, communications, and consultations sections all contain information pertinent to the treatment of the medical condition. This medical condition page provides a treatment group for the group of medical practitioners that collaborate to treat Mary Martin's breast cancer. They contribute in a threaded chat where the practitioners can share pertinent information, post office notes or external medical records or call for a collaborative medical consultation session online related to the medical condition which the object of the medical condition subcategory page. This provides a unique, problem or medical condition focused collaborative workspace for practitioners that may practice in separate medical systems and may not be able to communicate together without this application. The heart of this “Medical Condition” page is the threaded chat between physicians. One physician may add that he has ordered a new imaging study and request that another physician review the results and comment. This post would appear on that physician's dashboard and all physicians on the distribution list for the federated record chat or forum with need to know or involved in the treatment of this condition. Another physician may report that has evaluated the patient and post his office note. Another physician may add that he has an old record from many years ago and post the record. A recording of a collaborative consultation session between three of the patient's treating physicians may also be posted in the chat. An invite for a live consultation session may also be posted in the federated record and simultaneously on the calendar of all the physicians that accept the invite. Each of the physicians would receive a notification email or IM prior to the session.

Meta tags are used to associate content to identify interested parties and to distribute content amongst the various subcategories and to link content to clinical scenarios and to identify information that would be of most interest to various user types. For example, physicians may have more need for clinical information and medical decision making information whereas, medical assistants may be most interested.

### Example

This is a real life demonstration of a collaborative, problem oriented work session or medical project management plan. The patient dashboard would include a listing of the patient's diagnoses that would be catalogued against the corresponding ICD-10 codes. As aside, a physician would be able list all his patients that have a specific ICD10 and cross reference a particular treatment or medication in order to determine if the treatment is successful or establish trending in complications or side effects. This would be useful in the future where physicians are compensated by patient outcome rather than fee-for-service model If the physician decides to work on a particular patient's record or is called into the patient's treatment by another physician, a timer and work session documentation log is initiated. This timer clocks the amount of time dedicated to the care of this patient and records a log of all actions (e.g. review diagnostic imaging reports and imaging, review laboratory reports, review problem oriented chat or Forum, participate in collaborative multi-physician consultation session). These logs would be useful for validating time spent on a particular patient for billing purposes and to document collaboration with other physicians. Because all physicians contribute while logging into the same system, all portions of the treatment activity is logged and is recorded to document time, treatment activity, and consultation. This information can be exported to the users' EMR systems but the functional work space takes place in the single cloud based Federated medical record. This centralized log of professional work product will be important for billing purposes of diagnosis and treatment of a patient that is not physically present at the time of the treatment. Since the user must be personally logged in to perform this work and the system logs every action, it would not be possible to cheat and it should provide ample documentation of work product for billing purposes. This logging and billing documentation system will also be useful for documenting oversight of physician's assistants and nurse practitioners that may perform the initial review of records and screen the most pertinent records for review by the physician that supervises their medical care. For example, the supervising physician may have a filter set that he reviews the patient records of any patient with a complication, drug reaction, or hospital admission or any other adverse outcome marker. The performance could be matched against all other similar professions in the database caring for patients with similar DRG and/or ICD-10 codes for outcome based performance measures. Any of these adverse events would trigger a notification and would appear on a separate dashboard for supervising physicians. A system generated notification would go out to the treatment team and the supervising physician repeatedly until they acknowledge receipt. ILLUSTRATION: For example, let's say that an orthopedic surgeon, Dr. Cutter, has received a notification email that his consultation is requested to evaluate a patient with a diabetic foot and concern about osteomyelitis of the second toe. The consultation was generated by the patient's primary care physician, Dr. Good. Dr. Cutter clicks on the system generated link in the invitation email and logs into the system using his tablet computer (authenticating using a login/password or biometric authentication). The link directs Dr. Cutter directly to a collaborative medical treatment project already in session with a 3 month history of treatment transactions. Dr. Cutter sees a listing of the patient's other diagnoses (with hotlinks that would take him to a dashboard for all transactions related to that diagnosis in this patient) and a listing of all the physicians involved in this patient's care (also hotlink to dashboard that would include all transactions in which this particular physician or provider has been involved). Each of the patient's diagnoses is categorized as a separate treatment “Diagnosis” with separated “subdiagnosis” and “Action Items”. In this case the patient has type 1 diabetes mellitus as a major diagnosis. Under the diabetes major project, there are subcategories for “Diagnosis”, “Prevention”, “Treatment”, “Co-morbidities”, “Complications”. Dr. Cutter has been directed to the subcategory “Complications” and the sub-diagnosis “osteomyelitis”. He is directed to a threaded chat in session and sees that the last post is by Dr. Badbone, an infectious disease doctor that was invited into the treatment workgroup session by Dr. Good after reviewing MRI images of the foot and report by the radiologist, Dr. Bonerad that describes abnormal MRI appearance of the distal phalanx of the second ray of the right foot. Dr. Cutter clicks on the link to this MRI and views the report and images. He sees that Dr. Bonerad had access to a previous MRI from another imaging center that he contributes and which has been added to the record and Dr. Cutter reviews the images and report. Dr. Cutter sees that Dr. Bonerad has attached the salient images from the previous MRI that showed normal bone marrow appearance and the new MRI that shows the new abnormal marrow edema. Dr. Cutter sees that Dr. Good reviewed the imaging report and requests a consultation by Dr. Badbone, the infectious disease doctor. There is a posting by Dr. Badbone including a link to his imported office notes and a video if the patient's foot at the time of the initial visit and a single frame capture still photo showing a swollen, red toe. Subsequent posts by Dr. Good show that antibiotics were initiated and that a clinical photo and video show that the toe became more swollen and red despite treatment. A follow-up MRI showed that marrow edema and soft tissue swelling had increased and that there was new bone destruction suggesting osteomyelitis with a new soft tissue abscess. Dr. Cutter sees that Dr. Good (PCP) reviewed the radiology report and requested a collaborative consultation session between Dr. Good (PCP), Dr. Bonerad (radiologist), and Dr. Badbone (infectious disease). Dr. Cutter reviews a recording of the session where all three physicians were in attendance from their respective offices and attended a treatment conference where the clinical images of the toe, laboratory and radiology findings were reviewed. Dr. Cutter reviews the consultation request generated by Dr. Good as result of the collaborative consultation session. Dr. Good has attached some other supporting documents regarding the problem from a physician that does not participate in the system. When Dr. Cutter clicked on the link to the notification email, Dr. Good received a notification email that Dr. Cutter has received the request and a timer initiates that will notify both physicians if Dr. Cutter fails to respond by adding a posting within 24 hours. After reviewing the postings and attachments, Dr. Cutter adds a posting that he would like to discuss the location of the soft tissue abscess with Dr. Bonerad and Dr. Cutter sees that Dr. Bonerad is currently online Dr. Cutter clicks on the hotlink by Dr. Bonerad's name which sends a collaborative session invitation to Dr. Bonerad. This invitation request pops up on Dr. Bonerad's computer and he accepts. The two physicians are now viewing the image that Dr. Bonerad had selected as showing the abscess. The two physicians are chatting using integrated voice over internet protocol (VOIP). Dr. Cutter circles an area of concern using HTML5 tools and selects “update”. Both physicians are viewing the annotated image residing on the cloud and each physician adds an annotation or selects another image and selects “update”. The images and voice annotation are recorded so that they can be viewed at a later time by other medical providers or insurance entities, etc. Dr. Cutter thinks that need an opinion from Dr. Badbone (infectious disease) and sees that he is online and clicks on his name to invite him into the discussion real time. The three physicians agree that the patient needs and amputation and abscess drainage and that it should be performed as soon as possible and conclude the session. The three physicians participate in different medical facilities with different EMR systems that do not allow video capture or importing for security reasons. The three physicians do not have privileges to each other's EMR system but they were able to collaborate together in this problem oriented session. Dr. Cutter invited his physician's assistant, PA Helper into the case to arrange for the surgery. PA helper reviews the series of posts and contacts the patient to discuss the situation and the plan and suggest that the patient consult with Dr. Cutter who is currently in surgery. The patient agrees with the treatment plan and electronically signs the authorization forms after logging in to the system from the BioMedBox Kiosk at the pharmacy where he receives antibiotics. PA helper invites the surgical pre-authorization staff in his office into the process for insurance pre-authorization. The insurance verifier requests copies of documentation included in the thread including the patient information, medical professionals that treated the patient, supervising physician, and other pertinent medical information.

FIG. 3 demonstrates the user landing page or dashboard page for Radiology Results. The User dashboard includes several sections including: available Tabs displaying other available viewing pages; recent Alerts section; recent Communications section; user Favorites section and Recent Studies section. The tabs display other pages that are available for the user to view data in another context than the homepage. The Alerts section contains a listing of important notifications any of any of a variety of types including: Status changes, addendums added to reports, urgent files, or urgent communications. The Communications section lists recent unviewed communications including: chat sessions, emails, collaborative sessions, and system notifications and alerts. The Favorites section lists information about the user's profile and lists the users favorite users, colleagues and referral sources. An indicated next the users name designates whether the user is currently online and available for a real time (also known as “synchronous”) communication or collaboration. The Patient List section displays a list of the user's most recent radiology cases sorted from newest to oldest. The user can access the images on a study by selecting on the patients name and can access a finalized report by selecting the word “Final”. At the bottom of the page are links to tools available to the user including: Help, Search, GoToRad, and eRXray (electronic ordering of radiology studies).

FIG. 4 demonstrates sample Alerts, Communications, and Sample Patient list.

FIG. 5 shows a User Dashboard, Laboratory Results Tab. This Laboratory Results tab includes: Alerts of Critical Findings laboratory results, Communications section listing communications related to laboratory results; user Favorites, and recent Laboratory Results list. The recent laboratory results lists results from newest to oldest.

FIG. 6 demonstrates a patient dashboard or federated medical record pertaining to a given patient is collated onto one page. The patient's dashboard is divided into five tabs: the homepage, reports, images, documents and laboratory results. The homepage is demonstrated in the figure. The homepage lists the Alerts and Communications pertaining to the care of this particular patient. Critical alerts are highlighted and flash with a pop-up until the user confirms message receipt. This is an important part of the critical findings notification system. When such an alert is created, the user is notified by (phone, instant message, CMS, email) according to the preferences established by the user in his/her profile. The user is repeatedly notified until the user confirms that the message is received. If the receipt is not received within a specified period of time the system escalates to an administrator for manual action. As an example, the radiologist discovers a fracture or broken bone that needs immediate attention. The radiologist selects an icon that signifies that a critical finding has been discovered. When the icon is selected a pop-up window brings up an action window that has pre-populated the patient information and the demographic information of the physician that ordered the study. The radiologist is given the opportunity to add a text message or to record a voice message and to review the contact information of the referring physician. The radiologist can also add a personal note or special contact information to the note. The radiologist selects one of three levels of urgency of the notification Critical, urgent, important. The levels translate into how urgently the notifications will ping the physician and how quickly the notification will be forwarded to an administrator and trigger a separate set of best practices for critical findings notification. Once the radiologist choses “send” the application access the recipient physician's user preferences and selects the preferred method of notification. A system generated notification using email, Twitter, SMS, or phone call. The notification notifies the recipient that there is an urgent notification is ready for retrieval and includes a link to the message. The user selects the link and is directed to login. The user selects an icon to enter login or password or is prompted to enter the login passphrase to enter by voice recognition and face recognition on mobile device. The mobile device captures the voice recording and transmits to the web based evaluation software and archive database within the authentication module software. The recipient is authenticated and directed to the target of the link with the notification from the radiologist, the radiology report, and the directions about any follow-up or contact information for the radiologist. The notification method includes a link to the alert and the user logs in to retrieve and confirm and action items (e.g. call radiologist at phone number ###-###-####) are included in the retrieved message. Simultaneously, the radiologist is sent a notification that the message has been delivered and the application logs the notification. If the recipient does not pick up the notification within a pre-specified amount of time, an administrator will be notified for more manual follow-up. The frequency of notification transmission is selectable and default is related to the selected urgency. In general, the higher the urgency, the more frequent the notification and the sooner the notification is forwarded to the administrator. The critical findings notification process assures that the recipient physician is notified and that the loop is closed and that there is method for escalation related to the clinical urgency of the finding.

The patient homepage includes the patient's profile information including a list of the patient's treating physicians and a designation of whether this physician or health provider is currently logged into the application. The user may request a real time, online consultation with an online medical provider by simply clicking on the provider's name. This hyperlink initiates a request for online consultation described in previously submitted application.

The home page also includes a listing of the patient's medical diagnoses and medications. If one selects the medical diagnosis from the list, the user is taken to a dashboard of communications, alerts, laboratory testing and radiology results pertinent to the evaluation and treatment of this condition in this patient.

The home page also lists the most recent 10 diagnostic imaging (radiology) studies for this patient. The reports and/or images for all the studies that have been obtained from various imaging centers, hospitals or medical offices are collated into OneList™. Finalized reports are available for studies where the word “Final” is listed as the status. If the user clicks on the hyperlink word “Final”, the user is taken to the report page. If the user clicks on the hyperlink of the date of the desired exam, the user is redirected to a non-diagnostic DICOM viewer to sample the images for the convenience of the user. If the user needs access to an FDA approved diagnostic DICOM viewer, a link is provided to the study using a DICOM viewer approved for diagnostic medical use.

The patient home page contains the same tabs at the lower right corner where the user can request online help, search for a particular record, request a consultation with a radiologist, or order an additional radiology study.

FIG. 7 demonstrates the “Report Review” page to which a user is transferred after selecting the hyperlink of the date on the list of studies form the patient home page radiology studies list. The radiology report is presented in a panel on the right with attached annotated key images (RadPics™) that were selected by the interpreting radiologist with annotations demonstrating the salient findings.

The panel to the left of the page lists information about the radiologist that interpreted the study including a picture, biographic information and a selectable hyperlink to the radiologist's curriculum vitae. There is also a method to recommend the radiologist to a colleague or imaging center. The radiologist's average rating from other users is listed. The application indicates whether the radiologist is currently online and provides a hyperlink to initiate a real, time, online collaboration session with the radiologist.

The report page also provides an opportunity for the user to give feedback (eRate) the report generated by the radiologist according to modifiable criteria. In this example, the user is asked if the user agrees with the radiologists conclusion in the report, whether the user is satisfied with the detail of reporting, whether the user recommends (i.e. favors the radiologist), and whether the user desires that more of his patient's studies are interpreted by this radiologist. This “social media” style reporting or eRate has been previously described in filing U.S. patent application Ser. No. 13/354,219 (19 Jan. 2012). The results would be used to decide work case distribution so that the studies referred by users would be distributed to radiologists that they rate highest. It could also be used for contracting and pricing negotiations where centers might pay for various levels of user satisfaction rating.

FIG. 8 shows the Images tab including the non-diagnostic DICOM viewer called PACS-Lite®. The logo of the imaging center that produced the study and the average “social media” (eRate) rating by other medical providers and patients is provided. By clicking on the imaging center's icon, the user is directed to a new page showing more detailed information about the imaging center.

In the panel on the right, the user sees a sample images from the imaging study that the user selected from the list of the patient's imaging studies above. The user uses drop-down menus to select other studies from the patient or to select the particular series of images from the study selected. If the user wants to view a specific image that was referred to by the radiologist in the report, the user can select a particular image. The user could also select a series from the displayed thumbnail representations. A single image full resolution image is displayed and the user can utilize a limited palette of tools to adjust the appearance and orientation of the image using the tools to the left. The tools are designed to operate properly in a variety of operating systems without the need of specific applications such as FLASH.

In the lower left corner is the eRate feedback panel where the user rates the image quality and the user's rating of how well the imaging study displayed the clinical findings for which the patient was referred for imaging evaluation.

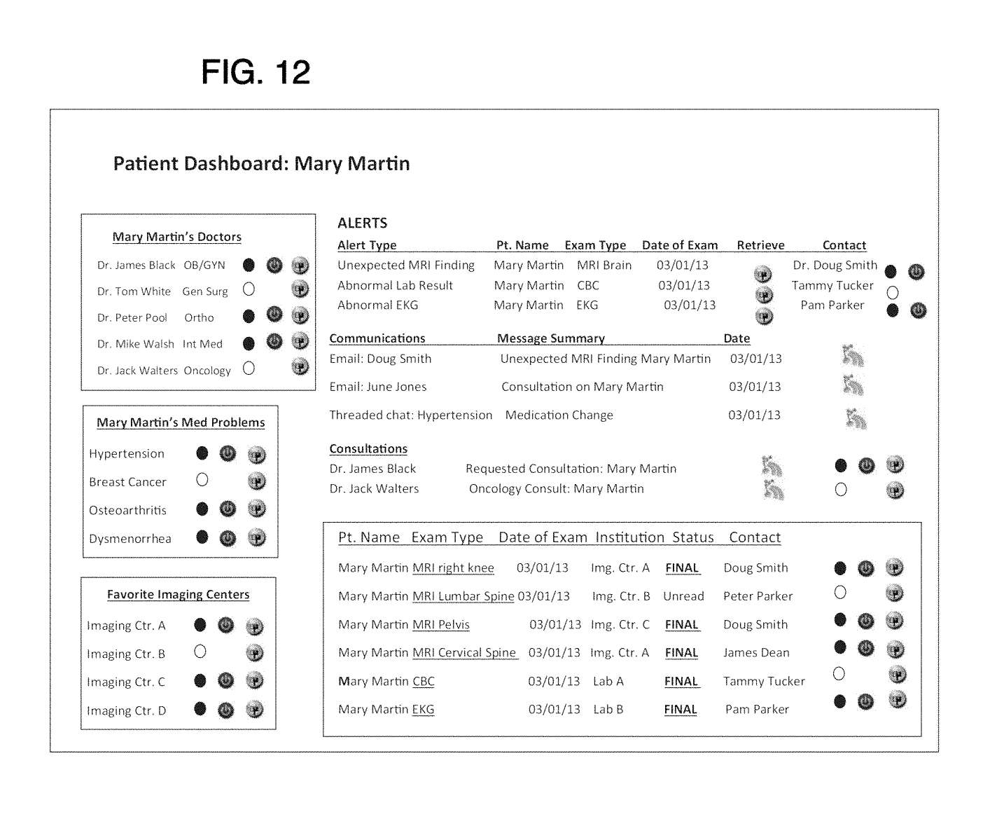

FIG. 12 shows the Documents tab of the patient's section. This section lists supporting documents that apply to the patient's care. The supporting documents could be office notes, reports of studies performed at non-participating centers and contributed by users or added from any of the data feeds, or added by the patient. The documents are organized from newest to oldest. Each report has attached META tags that allow the report to be searched for and displayed with the appropriate diagnosis or treating medical professional.

FIG. 10 shows the Laboratory Results tab that demonstrates the laboratory results for the patient. The lab results are listed from newest to oldest although the results could be sorted by any parameter including type of test, test result level, date, ordering physician, etc. If the user selects on the hyperlink of the name of the desired study, a new window is opened that displays the laboratory report. There is also a section for alerts related to this patient's laboratory results and communications pertinent to laboratory results of this patient. The user can order a laboratory test by selecting a hyperlink to the electronic ordering application for laboratory ordering.

Preferred embodiments of the invention incorporate a laboratory report shown after the user selects the hyperlink of the desired report. The user can use eRate to rate the service provided by the laboratory. The user can forward the lab result to another user or add another user to the distribution list. If the user is concerned one could generate an Alert for this lab report or initiate a communication with another user or distribution lists in regard to this laboratory report.

FIG. 9 shows the Radiologist tab of the PEERS section. A user views the radiologists that have most frequently read studies that the user has ordered. The user can see if the radiologist is currently logged into the application and the average eRating of the radiologist. If a radiologist is selected, a picture and bio are displayed in the panel on the right. In the lower left, the user can send a secure email or instant message to the radiologist. The user can also send a message to the application administrator related to the radiologist.

FIG. 11 shows the Client MD tab where the medical providers that refer patients to the user are listed. This is an important section for specialists to assure that the primary care physicians and referral sources are kept informed as the specialist cares for a patient that are shared by the specialist and the PCP. If one selects a client, the page shows a picture of the MD, and list of emails, instant messages (IMs), and number of referrals of patients between the user and this MD. At the lower right is a list of patients that are common to both the user and the selected MD. The user can initiate a referral to the selected MD by selecting a hyperlink.

Preferred embodiments of the invention incorporate a Consulting MDs_tab that displays a list of physicians or medical providers to whom the user refers patients for medical treatment. The application displays the user's most frequently utilized referring health providers, their specialties, whether the consultant is online, and the percentage of referrals made to that consultant in the appropriate category. If one selects consulting MD, the page shows a picture of the MD, and list of emails, instant messages (IMs), and number of referrals of patients between the user and this MD. At the lower right is a list of patients that are common to both the user and the selected MD. The user can initiate a referral to the selected MD by selecting a hyperlink.

Preferred embodiments of the invention incorporate a Dynamic Filter tab of the Centers section. This section relates to information pertaining to imaging centers. When a user wants to select the most appropriate imaging center to which to refer his patient based on the particulars of his patient's need, the user uses the dynamic filter that has been described in another filing U.S. patent application Ser. No. 13/354,219 (19 Jan. 2012). The user lists a series of parameters in order of importance or rank order and the dynamic filter lists the participating imaging centers that meet the stated criteria. The results are listed on the right along with a logo hyperlink of the center. Selecting on the hyperlink opens a page that displays additional information about the imaging center. The eRate results of patient's ratings of the imaging center are listed. If the user selects the name of the imaging, center the user is transferred to an electronic ordering page.

Preferred embodiments of the invention incorporate a Favorites tab of the Centers section. The application ranks the imaging centers to which the user's patients have been referred form most common to least common. The patient (eRate) rating for each center is also listed. When the user selects a center by checking the box by the name, the program updates the information on the right to display information about this imaging center including address, contact information, hours of operation, and a designation of alerts related to the center and communications between the center and medical providers related to the user's patients.

Preferred embodiments of the invention incorporate an Information tab of the Centers section. A user may want to gain information about a particular center and selects a center in the scrollable list of participating imaging centers. Once the user selects a center, information about the hours of operation, insurance plans accepted by the center, radiologists that are affiliated with the center, and listing of services available are displayed. In addition, the user can request directions from a map and directions application.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In the foregoing specification, specific embodiments have been described. However, one of ordinary skill in the art appreciates that various modifications and changes can be made without departing from the scope of the disclosure as set forth in the claims to follow in a subsequent disclosure. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all subsequent claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

I claim:

1. A system, comprising:
Aggregating records containing health information into a database in association with medical providers and their corresponding patients;
Determining whether a user should have access to health information;
Subsequently providing access to health information to said user, if appropriate; and
Enabling said user to view, edit and share health information via a federated collaborative medical record system.

2. A method to store, manipulate and share information relevant to medical records, said method comprising:
Accessing a federated collaborative medical record system;
Viewing information relevant to a medical record by accessing said federated collaborative medical record system;
Editing information relevant to a medical record by accessing said federated collaborative medical record system; and
Storing information relevant to a medical record by transforming a storage medium, said storage medium being accessible via the federated collaborative medical record system to one other remote user or a plurality of other remote users.

3. The method in claim 2, further comprising:
Viewing information relevant to a medical record within the federated collaborative medical record system concurrently or asynchronously with other users also accessing the federated collaborative medical record system;
Editing information relevant to a medical record within the federated collaborative medical record system concurrently or asynchronously with other users also accessing the federated collaborative medical record system; and
Storing information relevant to a medical record after it has been edited by transforming a storage medium, said storage medium being accessible via the federated collaborative medical record system to one other remote user or a plurality of other remote users.

4. The method in claim 2, further comprising:
Assigning a meta tag or a plurality of meta tags to data accessible via the federated collaborative medical record system;
Storing said meta tag in association with said data on a storage medium accessible to users of the federated collaborative medical record system by transforming said storage medium.

5. The method in claim 4, further comprising:
Searching of data accessible via the federated collaborative medical record system by meta tag.

6. The method in claim 2, further comprising:
Appending information relevant to a medical record with comments contributed by a user of a federated collaborative medical record system via said federated collaborative medical record system and storing said comments in a medium accessible via said federated collaborative medical record system to another user or other users of said federated collaborative medical record system.

7. The method in claim 2, further comprising:
Appending information relevant to a medical record with medical provider notes contributed by a user of a federated collaborative medical record system via said federated collaborative medical record system and storing said notes in a medium accessible via said federated collaborative medical record system to another user or other users of said federated collaborative medical record system.

8. The method in claim 2, further comprising:
Transforming information relevant to a medical record into a standardized format that a system can subsequently import;
Exporting said information to said system.

9. The method in claim 2, further comprising:
Inviting another person to contribute documentation pertinent to a specific patient via a federated collaborative medical record system.

10. The method in claim 2, further comprising:
Documenting information pertaining to a patient's complaint by appending information relevant to a medical record with medical provider notes via a federated collaborative medical record system.

11. The method in claim 2, further comprising:
Documenting information pertaining to a patient's vital signs by appending information relevant to a medical record with medical provider notes via a federated collaborative medical record system.

12. The method in claim 2, further comprising:
Documenting information pertaining to diagnostic test results by appending information relevant to a medical record with medical provider notes via a federated collaborative medical record system.

13. The method in claim 2, further comprising:
Documenting information pertaining to diagnostic laboratory results by appending information relevant to a medical record with medical provider notes via a federated collaborative medical record system.

14. The method in claim 2, further comprising:
Documenting information pertaining to patient symptoms by appending information relevant to a medical record with medical provider notes via a federated collaborative medical record system.

15. The method in claim 2, further comprising:
Documenting information pertaining to patient diagnoses by appending information relevant to a medical record with medical provider notes via a federated collaborative medical record system.

16. The method in claim 2, further comprising:
Documenting information pertaining to planning steps associated with the treatment of a patient by appending information relevant to a medical record with medical provider notes via a federated collaborative medical record system.

17. The method in claim 2, further comprising:
Appending information relevant to a medical record with documentation pertaining to medical testing contributed by a user of a federated collaborative medical record system via said federated collaborative medical record system;
and
storing said documentation in a medium accessible via said federated collaborative medical record system to another user or other users of said federated collaborative medical record system.

18. The method in claim 2, further comprising:
Sending to one other person or a plurality of other persons, via a federated collaborative medical record system, documentation pertinent to a specific patient.

19. The method in claim 18, whereby the documentation is delivered to one other person or a plurality of other persons by a federated collaborative medical record system generating an e-mail directed to said other person or plurality of other persons.

20. The method in claim 2, further comprising:
Transmitting, via a federated collaborative medical record system generating, an order directed to one other user or a plurality of other users of said federated collaborative medical record system information relevant to a medical record accessible via the said federated collaborative medical record system.

21. The method in claim 20, whereby the order is delivered to one other person or a plurality of other persons by a federated collaborative medical record system generating an e-mail directed to said other user or plurality of other users.

22. The method in claim 20, whereby said other user or said plurality of other users receives a notification that said order has been transmitted.

23. The method in claim 2, further comprising:
Categorizing information relevant to a medical record into groupings of data.

24. The method in claim 23, further comprising:
Searching information relevant to a medical record based upon said groupings of data.

25. The method in claim 23, further comprising:
Labeling information relevant to a medical record with an identifier specifying the user of a federated collaborative medical record system that contributed said information relevant to a medical record.

26. The method in claim 25, further comprising:
Searching information relevant to a medical record based upon an identifier specifying the user of a federated collaborative medical record system that contributed said information relevant to a medical record.

27. The method in claim 2, further comprising:
Importing the categories utilized in a system;
Allocating to a specific item of data stored within a medium accessible via a federated collaborative medical record system a subset of category identifiers selected from the categories utilized in said system.

28. The method in claim 27, further comprising:
Searching information relevant to a medical record based upon said category.

29. The method in claim 2, further comprising:
Appending an item of information with location and context data; and
storing said item of information by transforming a medium accessible via a federated collaborative medical record system.

30. The method in claim 2, further comprising:
Linking to a data repository;
Reproducing information from said data repository onto a storage medium accessible to users of a federated collaborative medical record system;
Storing said information by transforming a storage medium accessible to users of a federated collaborative medical record system and subsequently displaying said information upon the request of a user.

31. The method in claim 2, further comprising:
Pre-authenticating a user;
subsequently granting access to said user to a federated collaborative medical record system;
recording the activities of said user as said user interacts with a federated collaborative medical record system;
collecting information pertinent to said user's activities on a federated collaborative medical record system; and
storing said information on a medium accessible to users of a federated collaborative medical record system.

32. The method in claim 31, whereby the information pertinent to said user's activities on a federated collaborative medical record system comprises audio and video information collected from devices connected to user equipment.

33. The method in claim 2, further comprising:
Inviting a first user to a multi-user session taking place on a federated collaborative medical record system;
Transmitting a notice to a subsequent user that said first user has been invited;
Providing access to said subsequent user to join said multi-user session on a federated collaborative medical record system;
Storing activities that take place during said multi-user session by transforming a storage medium accessible to users of a federated collaborative medical record system.

34. The method in claim 33, whereby said multi-user session is accessible via a web page.

35. The method in claim 33, whereby a user taking part in said multi-user session is removed from said multi-user session after a period of inactivity.

36. The method in claim 2, further comprising:
Accessing medical images stored on a remote system,
Previewing medical images via a federated collaborative medical record system,
Annotating medical images via a federated collaborative medical record system,
Sharing annotations of medical images with other users of a federated collaborative medical record system via a federated collaborative medical record system,
Storing annotations of medical images within a medical record by transforming a storage medium accessible to users of a federated collaborative medical record system.

37. The method in claim 2, further comprising:
Prioritizing specified data elements related to a medical record for transfer to a user via a federated collaborative medical record system in a way that other unspecified data elements that otherwise would require bandwidth for transfer are not transferred.

38. The method in claim 2, further comprising:
Aggregating data relevant to which users have logged in to a federated collaborative medical record system; and
displaying to a user which users have logged in to a federated collaborative medical record system.

39. The method in claim 38, further comprising:
Inviting a user that is logged in to collaborate via a federated collaborative medical record system.

40. The method in claim 2, further comprising:
Selecting specified users who are directly involved in the care of a specified patient, Linking said specified users together to enable said specified users to communicate with each other in real time via audiovisual means;
Displaying documents pertinent to the care of a specified patient to specified users within a federated collaborative medical record system;
Preventing other unspecified users from observing or listening to the audiovisual communications of said specified users.

41. The method in claim 40, further comprising:
Recording said audiovisual communications of said specified users;
Storing said audiovisual communications by transforming a storage medium accessible via a federated collaborative medical record system;
Displaying said audiovisual communications to any of said specified users at a later time by retrieving said communications from said storage medium accessible via a federated collaborative medical record system.

42. The method in claim 2, further comprising:
Timing the usage period in which a user accesses the workspace;
Determining whether the user performs significant activity within the workspace by measuring and evaluating said user's computer mouse movements;
Excluding from the timing of said user's usage period portions of insignificant activity;
Identifying which particular activities said user performed and which particular patients said user's activities related to during said usage period;
Storing the information related to which particular activities said user performed and which particular patients said user's activities related to during said usage period in a work product log by transforming a storage medium accessible via a federated collaborative medical record system;
Exporting said work product log to an external system, thereby transforming said external system.

43. The method in claim 42, further comprising:
Collecting data relevant to whether a user is under the direction of another medical provider;
Collecting data relevant to the area of medical practice said user's activities relate to;
Creating a log of which medical provider has directed said user and the areas of medical practice to which said user's activities relate;
Appending a medical record with said log and storing said medical record by transforming a storage medium accessible via a federated collaborative medical record system.

44. The method in claim 42, further comprising:
Exporting said log to an external system.

45. The method in claim 42, further comprising:
Delivering to an insurance carrier said log for purposes related to billing.

46. The method in claim 2, further comprising:
Authenticating a user to enable access to a federated collaborative medical record system;
Enabling said user to edit information relevant to a medical record via a federated collaborative medical record system;
Appending the medical record with information identifying the said user and the time the said user edited the medical record;
Storing the appended medical record by transforming a storage medium accessible via a federated collaborative medical record system.

47. The method in claim 46, further comprising:
Grouping together users that access or edit a patient's medical record via a federated collaborative medical record system into a workgroup;
Notifying users within said workgroup when said patient's medical record has been edited by a user in said workgroup.

48. The method in claim 46, further comprising:
Receiving a medical image from a medical imaging facility;
Identifying the patient that is the subject of said medical image;
Appending said patient's medical record with said medical image;
Notifying users within said patient's workgroup that said patient's medical record has been updated with a medical image.

49. The method in claim 46, further comprising:
Receiving a test result from a laboratory;
Identifying the patient that is the subject of said test result;
Appending said patient's medical record with said test result;
Notifying users within said patient's workgroup that said patient's medical record has been updated with a said test result.

50. The method in claim 46, further comprising:
Subdividing workgroups into sub-workgroups of users appropriate to address a specific medical problem affecting a patient who the subject of a medical record;
Notifying users within a sub-workgroup when the information contained within said medical record related to said specific medical problem is edited by a user of said sub-workgroup.

51. The method in claim 46, further comprising:
Logging when a user who is a member of a workgroup has received an e-mail sent to users who are members of a workgroup containing a link to test results pertinent to a medical record relevant to the workgroup when said test results are received;
Logging when a user who is a member of a workgroup has viewed an e-mail sent to users who are members of a workgroup containing a link to test results pertinent to a medical record relevant to the workgroup when said test results are received;
Logging when a user who is a member of a workgroup has clicked on a link within an e-mail sent to users who are members of a workgroup containing a link to test results pertinent to a medical record relevant to the workgroup when said test results are received;
Appending said medical record when said test results are received with logging information relevant to which workgroup users have or have not received e-mail notifications, viewed e-mail notifications, and clicked on links to results contained within e-mail notifications; and
Storing the appended medical record by transforming a storage medium accessible via a federated collaborative medical record system.

52. The method of claim 46, further comprising:
Storing logs of which users have or have not received notifications of edits to medical records and have or have not viewed edits to medical records by transforming a storage medium accessible via a federated collaborative medical record system;
Displaying a list denoting which users have received notifications of edits to medical records and which users have not received notifications of edits to medical records;
Displaying a list denoting which users have viewed edits to medical records and which users have not viewed edits to medical records.

53. The method of claim 46, further comprising:
Annotating a medical record with the identities of users who have viewed or edited said medical record;
Storing the annotated medical record by transforming a storage medium accessible via a federated collaborative medical record system.

54. The method of claim 2, further comprising:
Appending a medical record with a journal article;
Storing the appended medical record by transforming a storage medium accessible via a federated collaborative medical record system.

55. The method of claim 2, further comprising:
Appending a medical record with a user's comments;
Storing the appended medical record by transforming a storage medium accessible via a federated collaborative medical record system.

56. The method of claim 2, further comprising:
Appending a medical record with video content;
Storing the appended medical record by transforming a storage medium accessible via a federated collaborative medical record system.

57. The method of claim 2, further comprising:
Appending a medical record with visual content in the form of images related to pathology;
Storing the appended medical record by transforming a storage medium accessible via a federated collaborative medical record system.

58. The method of claim 2, further comprising:
Appending a medical record with photography content;
Storing the appended medical record by transforming a storage medium accessible via a federated collaborative medical record system.

59. The method of claim 2, further comprising:
Formatting data in such a way that said information related to a medical record can be imported into a separate system;
Connecting with a separate system;
Sending data to a separate system.

60. The method of claim 2, further comprising:
Identifying information pertinent to a patient known within a federated collaborative medical record system from a medical record stored within a separate system;
Retrieving information from said separate system and assimilating said information into the relevant patient medical record within a federated collaborative medical record system;
Subsequently storing said relevant patient medical record by transforming a storage medium accessible via a federated collaborative medical record system.

61. The method of claim 2, further comprising:
Structuring data related to a patient's care in note stored within a storage medium accessible via a federated collaborative medical record system;
Accessing said data from within a federated collaborative medical record system in real time pursuant to follow up consultations with said patient;
Editing said data from within a federated collaborative medical record system in real time pursuant to follow up consultations with said patient;
Including demographic information into said patient's medical record when edits are made;
Subsequently storing said patient's medical record by transforming a storage medium accessible via a federated collaborative medical record system.

62. The method of claim 2, further comprising:
Labeling and organizing said data relevant to a medical record with meta tags;
Circumventing limitations on the transfer of data relevant imposed by business entities;
storing said data relevant to a medical record and associated meta tags by transforming a storage medium accessible via a federated collaborative medical record system;
Searching for data relevant to a medical record by meta tag.

63. An apparatus comprising:
A client-server computer system including a server computer connected to a plurality of client computers over a wide area network;
wherein the server computer system:
receives a query relevant to a medical record from the client computer;
identifies a subset of data relevant to a medical record to send to the client computer;
sends a subset of data relevant to a medical record to the client computer; and wherein the client computer system:
receives a query input from a user;
generates the query relevant to a medical record relevant to said query input;
transmits said query relevant to a medical record to a server computer system;
receives the subset of data relevant to a medical record from said server computer system;
displays the subset of data relevant to a user query;
enables a user to save or copy a subset of data relevant to a user query.

64. The apparatus in claim 63, further comprising:
said client-server computer system;
wherein the client computer system:
receives data input from a user;
transmits data to a server computer system;
and
wherein the server computer system:
receives data from a client computer system;
allocates data to a database.

65. The apparatus in claim 63, further comprising:
said client-server computer system;
wherein the client computer system:
receives data input from a user relevant to the location or context of a subset of data relevant to a medical record;
and
wherein the server computer system:
receives data from a client computer system;
allocates data to a database.

66. The apparatus in claim 63, further comprising:
said client-server computer system;
wherein the client computer system:
receives data input from a user relevant to the a link to a record containing health information stored outside said client-server computer system;
and
wherein the server computer system:
receives data from a client computer system;
allocates data to a database.

67. The apparatus in claim 63, further comprising:
said client-server computer system;
wherein the client computer system:
records video with a video recordation system comprising a camera and a microphone to enable a user to record a video with information relevant to a medical record;
and
wherein the server computer system:
receives data from a client computer system;
allocates data to a database.

68. The apparatus in claim 63, further comprising:
said client-server computer system;
wherein the client computer system:
records biological sounds with a sound recordation device;
stores data relevant to biological sounds;
and
wherein the server computer system:
receives data from a client computer system;
allocates data to a database.

69. The apparatus in claim 63, further comprising:
said client-server computer system;
wherein the client computer system:
records sound with a sound recordation device to capture and store sound transmitted from a medical device, smart phone, mobile device, or stethoscope; and
wherein the server computer system:
receives data from a client computer system;
allocates data to a database.

70. The apparatus in claim 63, further comprising:
said client-server computer system;
wherein the client computer system:
senses biological motion with a motion sensing device;
stores data relevant to biological motion;
and
wherein the server computer system:
receives data from a client computer system;
allocates data to a database.

71. The apparatus in claim 63, further comprising:
said client-server computer system;
wherein the client computer system:
measures biological characteristics with a measuring device;
stores data relevant to biological characteristics;
and
wherein the server computer system:
receives data from a client computer system;
allocates data to a database.

72. The apparatus in claim 63, further comprising:
said client-server computer system;
wherein the client computer system:
receives from a user data relevant to the urgency of a subset of data relevant to a medical record;
associates with said subset of data relevant to a medical record a label indicating the urgency of said subset of data relevant to a medical record;
and
wherein the server computer system:
receives data from a client computer system;
allocates data to a database.

73. The apparatus in claim 63, further comprising:
said client-server computer system;
wherein the server computer system:
transmits to a client computer system data relevant to the urgency of a subset of data relevant to a medical record;
and
wherein the client computer system:
receives from a server computer system data relevant to the urgency of a subset of data relevant to a medical record;
displays data relevant to the urgency of a subset of data relevant to a medical record.

74. The apparatus in claim 63, further comprising:
said client-server computer system;
wherein the server computer system:
accepts simultaneous connections from a plurality of client computers in remote locations;
and
wherein the client computer system:
incorporates a user interface that allows a user to view a subset of data relevant to a medical record while other users utilizing other client computers simultaneously view said subset of data relevant to a medical record.

75. The apparatus in claim 63, further comprising:
said client-server computer system;
wherein the client computer system:
captures data relevant to patient communications via an audiovisual capture device;
stores data relevant to patient communications;
wherein the server computer system:
accepts simultaneous connections from a plurality of client computers in remote locations;
and
receives data from a client computer system;
allocates data to a database.

76. The apparatus in claim 63, further comprising:
said client-server computer system;
wherein the client computer system:
captures from a connected peripheral device data relevant to the identification information of said connected peripheral device;
associates said identification information of said connected peripheral device with a medical record;
and
wherein the server computer system:
receives data from a client computer system;
allocates data to a database

77. The apparatus in claim 63, further comprising:
said client-server computer system;
wherein the client computer system:
captures data relevant to the time period and location that a patient examination took place;
associates said data relevant to the time period and location that a patient examination took place with a medical record;
and
wherein the server computer system:
receives data from a client computer system;
allocates data to a database.

78. The apparatus in claim 63, further comprising:
said client-server computer system;
wherein the client computer system:
collects data;
encrypts data for transfer while data is in transit;
transmits encrypted data to a server computer system;
and
wherein the server computer system:
receives data from a client computer system;
decrypts data upon receipt;
encrypts data for storage at rest on a storage medium;
stores encrypted data on a storage medium.

79. The apparatus in claim 63, further comprising:
said client-server computer system;
wherein the client computer system:
collects data from a connected device while ensuring that said data is not stored within a data storage medium on said connected device;
encrypts data for transfer while data is in transit;
transmits encrypted data to a server computer system;
and
wherein the server computer system:
receives data from a client computer system;
decrypts data upon receipt;
encrypts data for storage at rest on a storage medium;
stores encrypted data on a storage medium.

80. The apparatus in claim 63, further comprising:
said client-server computer system;
wherein the client computer system:
receives data relevant to the identification of a user;
transmits said data relevant to the identification of a user to the server computer system;
and
wherein the server computer system:
receives said data relevant to the identification of a user;
authenticates said user;
authorizes said user;
receives a plurality of data relevant to a medical record from a client computer system entered by said user after said user has been properly authenticated and authorized;
stores a plurality of data relevant to a medical record as entered by said user in a database.

81. The apparatus in claim 63, further comprising:
said client-server computer system;
wherein the client computer system:
incorporates software and data comprising an electronic medical records system;
stores data relevant to the authentication and authorization of said electronic medical records system;
transmits data relevant to the authentication and authorization of said electronic medical records system to the server computer system;
transmits a plurality of data relevant to a medical record associated with said software comprising an electronic medical records system to the server computer system;
and
wherein the server computer system:
receives said data relevant to the authentication of an electronic medical records system;
authenticates said electronic medical records system;
authorizes said electronic medical records system;
receives a plurality of data relevant to a medical record from a client computer system associated with said electronic medical records system after said electronic medical records system has been properly authenticated and authorized;
stores a plurality of data relevant to a medical record as entered by said user in a database.

82. An article of manufacture comprising a set of application program interfaces designed to facilitate the exchange of data relevant to medical records between and among disparate data sources.

83. An apparatus comprising:
A client-server computer system including a server computer connected to a plurality of client computers over a wide area network;
Wherein the server computer system:
Stores a plurality of medical records;
Receives a medical record query from the client computer and identifies a subset of medical records to the client computer;
and
Wherein the client computer:
Receives a query input relevant to a medical record from a user;
Generates the medical record query;
Receives the subset of medical records and displays them to the user.

84. The apparatus in claim 83, further comprising:
said client-server computer system;
wherein the client computer system:
displays a graphical user interface featuring a collaborative workspace that enables a user to communicate with multiple other users each utilizing a separate client computer system connected to the server computer system to simultaneously view information.

85. The apparatus in claim 83, further comprising:
said client-server computer system;
wherein the client computer system:
a client computer that:
accesses a collaborative workspace hosted by the server computer system;
And
a server computer system that:
incorporates a source-neutral access mechanism to enable a user to access the collaborative workspace regardless of the type of electronic medical records system functioning on the user's client computer system.

86. The apparatus in claim 83, further comprising:
said client-server computer system;
wherein the server computer system:
incorporates an access means to allow a client computer system to connect with the server computer system regardless of the operating system of the client computer system.

87. A method comprising:
circumventing a system having authentication and authorization mechanisms to limit access to data.

88. The method in claim 87, wherein said system is an electronic medical records system.

89. The method in claim 87, wherein said authentication and authorization mechanisms primarily block medical professionals not affiliated with a particular business entity.

90. The method in claim 87, further comprising:
accessing an alternative federated collaborative medical record system that allows its users to contribute, search, and retrieve data.

91. The method in claim 90, wherein said data is data relevant to medical records.

92. A method, comprising:
authorizing a user;
authenticating said user;
connecting said user with other users within a collaborative workspace.

93. The method in claim 92, further comprising:
authorizing a user by collecting credentials as inputted by said user;
checking credentials to determine the appropriate access level of said user to a system;
providing appropriate access to said user to said system.

94. The method in claim 93, whereby the credentials are collected from an electronic medical records system.

95. The method in claim 93, further comprising:
providing to said user access to data relevant to medical records;
enabling said user to edit said data relevant to medical records simultaneously with another user or users;
storing said data by transforming a connected data storage medium.

96. The method in claim 92, whereby said system comprises a collaborative workspace.

97. The method in claim 93, whereby said collaborative workspace is connected to a plurality of electronic medical records systems which may contribute data to said system or receive data from said system.
